(19) United States
(12) Patent Application Publication
(10) Pub. No.: US 2016/0133266 A1
(43) Pub. Date: May 12, 2016

(54) Multi-Stage Quantization of Parameter Vectors from Disparate Signal Dimensions

(71) Applicant: DOLBY LABORATORIES LICENSING CORPORATION, San Francisco, CA (US)

(72) Inventors: Vinay MELKOTE, San Mateo, CA (US); Kuan-Chieh YEN, Foster City, CA (US); Grant A. DAVIDSON, Burlingame, CA (US)

(73) Assignee: Dolby Laboratories Licensing Corporation, San Francisco, CA (US)

(21) Appl. No.: 14/898,211

(22) PCT Filed: Jun. 17, 2014
(86) PCT No.: PCT/US2014/042696

§ 371 Date: Dec. 14, 2015

Related U.S. Application Data
(60) Provisional application No. 61/835,954, filed on Jun. 17, 2013.

(51) Int. Cl. G10L 19/038; H04N 19/94; G10L 19/008

(52) U.S. Cl. CPC G10L 19/038; G10L 19/008; H04N 19/94

(57) ABSTRACT

A first vector quantization process may be applied to two or more parameter values along a first dimension of the N-dimensional parameter set to produce a first set of quantized values. Two or more parameter prediction values may be calculated for a second dimension of the N-dimensional parameter set based, at least in part, on one or more values of the first set of quantized values. Prediction residual values may be calculated based, at least in part, on the parameter prediction values. A second vector quantization process may be applied to the prediction residual values to produce a second set of quantized values. These processes may be extended to any number of dimensions. Corresponding inverse vector quantization processes may be performed.

### CROSS-REFERENCE TO RELATED APPLICATIONS

This application claims priority to U.S. Provisional Application No. 61/835,954, filed on 17 Jun. 2013, incorporated herein by reference in its entirety.

### TECHNICAL FIELD

This disclosure relates to signal processing.

### BACKGROUND

Despite the increased capacity of memory devices and widely available data delivery at increasingly high bandwidths, there is continued pressure to minimize the amount of data to be stored and/or transmitted. For example, audio and video data are often delivered together, and the bandwidth for audio data is often constrained by the requirements of the video portion.

Accordingly, audio data are often encoded at high compression factors, sometimes at compression factors of 30:1 or higher. Because signal distortion increases with the amount of applied compression, trade-offs may be made between the fidelity of the decoded audio data and the efficiency of storing and/or transmitting the encoded data.

Moreover, it is desirable to reduce the complexity of the encoding and decoding algorithms. Encoding additional data regarding the encoding process can simplify the decoding process, but at the cost of storing and/or transmitting additional encoded data. Although existing data encoding and decoding methods are generally satisfactory, improved methods would be desirable.

### SUMMARY

Some aspects of the subject matter described in this disclosure can be implemented in signal processing methods and devices, including encoding and decoding methods and devices. Some such methods may involve receiving a signal and analyzing the signal to determine parameter values of an N-dimensional parameter set. As used herein, the phrase “N-dimensional parameter set” refers to a parameter set wherein each parameter is indexed in N dimensions.

In some implementations, the signal may include audio data. According to some such implementations, the dimensions may correspond to channels, frequency bands, time units (e.g., blocks), etc. In some implementations, parameters of the parameter set may include correlation coefficients between individual discrete channels and a coupling channel. These correlation coefficients may be referred to herein as “alphas.” Alternatively, or additionally, parameters of the parameter set may include inter-channel correlation coefficients that indicate a correlation between pairs of individual discrete channels. Such parameters may sometimes be referred to herein as reflecting “inter-channel coherence” or “ICC.” However, the signal processing methods and devices described herein are not only applicable to dimensions and parameters of audio data, but instead have wide applicability.

Some implementations involve applying a first vector quantization process to two or more parameter values along a first dimension of the N-dimensional parameter set to produce a first set of quantized values. Such implementations may involve calculating two or more parameter prediction values along a second dimension of the N-dimensional parameter set based, at least in part, on one or more values of the first set of quantized values. The implementations may involve calculating prediction residual values based, at least in part, on the parameter prediction values and applying a second vector quantization process to the prediction residual values to produce a second set of quantized values.

Some such implementations may involve determining a first vector quantization index corresponding to the first set of quantized values and determining a second vector quantization index corresponding to the second set of quantized values. The first and second quantization indices may, for example, include pointers to data structure locations at which the first and second sets of quantized values, respectively, are stored.

Some implementations may involve calculating two or more parameter prediction values along a k^{th} dimension of the N-dimensional parameter set, based at least in part on one or more values of one or more of (k−1) previously produced sets of quantized values, calculating prediction residual values based at least in part on the parameter prediction values along the k^{th} dimension and applying a k^{th} vector quantization process to the prediction residual values along the k^{th} dimension to produce a k^{th} set of quantized values.

Some such implementations may involve determining a maximum vector quantizer length Mₖ for dimension k and determining that a number of values Vₖ to be vector quantized exceeds Mₖ. Such implementations may involve determining Vₖ−Mₖ remaining values to be vector quantized and predicting, based at least in part on at least one of the Mₖ quantized values, Vₖ−Mₖ parameter prediction values along the k^{th} dimension. The implementations may involve calculating (Vₖ−Mₖ) k^{th} dimension prediction residual values and performing a vector quantization process for the (Vₖ−Mₖ) k^{th} dimension prediction residual values to produce Vₖ−Mₖ quantized values of the k^{th} parameter set.

According to some implementations, a method may involve receiving a signal and analyzing the signal to determine parameter values of an N-dimensional parameter set. In some implementations, the signal may include audio data. The method may involve applying a first vector quantization process to two or more parameter values along a first dimension of the N-dimensional parameter set to produce a first set of quantized values and calculating two or more parameter prediction values along a second dimension of the N-dimensional parameter set based, at least in part, on one or more values of the first set of quantized values. The method may involve calculating prediction residual values based, at least in part, on the parameter prediction values and applying a second vector quantization process to the prediction residual values to produce a second set of quantized values. A distortion metric used to design the quantizers or in codebook search in the performing process may be a mean squared error distortion metric.

The method may involve determining a first vector quantization index corresponding to the first set of quantized values and determining a second vector quantization index corresponding to the second set of quantized values. The first and second quantization indices may comprise pointers to data structure locations at which the first and second sets of quantized values, respectively, are stored.

The method may involve calculating two or more parameter prediction values along a k^{th} dimension of the N-dimensional parameter set, based at least in part on one or more values of one or more of (k−1) previously produced sets of quantized values, calculating prediction residual values based at least in part on the parameter prediction values along the k^{th} dimension and applying a k^{th} vector quantization process to the prediction residual values along the k^{th} dimension to produce a k^{th} set of quantized values.

The method may involve the following operations: determining a maximum vector quantizer length Mₖ for dimension k; determining that a number of values Vₖ to be vector quantized exceeds Mₖ; determining Vₖ−Mₖ remaining values to be vector quantized; predicting, based at least in part on at least one of the Mₖ quantized values, Vₖ−Mₖ parameter prediction values along the k^{th} dimension; calculating (Vₖ−Mₖ) k^{th} dimension prediction residual values; and performing a vector quantization process for the (Vₖ−Mₖ) k^{th} dimension prediction residual values to produce Vₖ−Mₖ quantized values of the k^{th} parameter set.

Determining the maximum vector quantizer length Mₖ may involve receiving an indication of the maximum vector quantizer length Mₖ from a user. The maximum vector length Mₖ may be a variable that controls a bit-rate for encoding parameters and may be determined based, at least in part, on an available bit-rate for parameter encoding.

The method may involve forming the parameter set into partitions of the parameter set in a signal-adaptive manner. In some implementations, the analyzing, applying and calculating processes may be applied separately on each partition of the parameter set. The forming process may vary in time.

The dimensions may include channels and/or frequency bands. The dimensions may include time blocks. The parameter values may include spatial parameter values. For example, the spatial parameter values may include correlation coefficients (“alpha values”) between individual discrete channels and a coupling channel. The prediction of an alpha value for a k^{th} stage of the method may involve a reconstruction of an alpha value of a (k−1)^{th} stage of the method.

The frequency bands may include coupling channel frequency bands. The alpha values may be shared across at least some adjacent time blocks. The method may involve performing a windowed calculation of alphas across at least one of time blocks or frequency bands.

The dimensions may include pairs of individual discrete channels. The parameter values may include inter-channel correlation coefficients (“ICCs”) that indicate a correlation between the pairs of individual discrete channels. The first dimension may correspond to pairs of individual discrete channels. The first vector quantization process may produce first quantized ICC values. For example, the first vector quantization may involve the following processes: quantizing a vector that includes ICCs of M−1 channel pairs in an Mₚ-channel-pair cycle, to produce quantized values of the M−1 ICCs; calculating a range in which the Mₚ^{th} ICC lies based, at least in part, on the quantized values of the M−1 ICCs; and quantizing the Mₚ^{th} ICC with a scalar quantizer, conditioned on the calculated range.

According to some alternative implementations, a method may involve receiving a signal comprising first and second vector quantization indices and performing a first inverse vector quantization operation in response to the first vector quantization index to reconstruct two or more parameter values along a first dimension of an N-dimensional parameter set. The method may involve determining two or more parameter prediction values of a second dimension of the N-dimensional parameter set based at least in part on one or more of the two or more parameter values of the first dimension of the N-dimensional parameter set, performing a second inverse vector quantization operation in response to the second vector quantization index to reconstruct two or more prediction residual values of the second dimension and combining the parameter prediction values of the second dimension with the prediction residual values of the second dimension to reconstruct two or more parameter values of the second dimension.

The method may involve the following processes: receiving a k^{th} vector quantization index; determining two or more parameter prediction values along a k^{th} dimension of the N-dimensional parameter set, based at least in part on one or more previously determined parameter values of a dimension less than k of the N-dimensional parameter set; performing a k^{th} inverse vector quantization operation in response to the k^{th} vector quantization index to reconstruct two or more prediction residual values of the k^{th} dimension; and combining the parameter prediction values of the k^{th} dimension with the prediction residual values of the k^{th} dimension to reconstruct two or more parameter values of the k^{th} dimension.

The method may involve the following processes: receiving an indication of a maximum vector quantizer length Mₖ for dimension k; determining that a remaining number of parameter values Vₖ to be reconstructed along dimension k exceeds Mₖ; reconstructing the first Mₖ values along dimension k based, at least in part, on the k^{th} quantization index; determining, based at least in part on the k^{th} quantization index, Vₖ−Mₖ parameter prediction values of the k^{th} dimension; receiving an additional vector quantization index for the k^{th} dimension; performing an inverse vector quantization operation, in response to the additional vector quantization index for the k^{th} dimension, to reconstruct Vₖ−Mₖ prediction residual values of the k^{th} dimension; and combining the Vₖ−Mₖ prediction residual values of the k^{th} dimension with the Vₖ−Mₖ parameter prediction values of the k^{th} dimension to reconstruct the remaining Vₖ−Mₖ parameter values of the k^{th} dimension.

According to some implementations, the first vector quantization index may correspond to a memory location of a first set of quantized values and the second vector quantization index may correspond to a memory location of a second set of quantized values.

The method may involve receiving parameter set partition information and implementing the performing and/or the determining steps according to the parameter set partition information.

The signal may include encoded audio data. The dimensions may include channels and frequency bands. The dimensions may include time blocks. The parameter values may be spatial parameter values. For example, the spatial parameter values may comprise correlation coefficients (“alpha values”) between individual discrete channels and a coupling channel. The frequency bands may include coupling channel frequency bands. In some implementations, the prediction of an alpha value for a k^{th} stage of the method may involve a reconstruction of an alpha value of a (k−1)^{th} stage of the method. In some examples, the alpha values may be shared across at least some adjacent time blocks.

The dimensions may include pairs of individual discrete channels. The parameter values may include inter-channel correlation coefficients (“ICCs”) that indicate a correlation between the pairs of individual discrete channels.

According to some implementations, an apparatus may include an interface and a logic system. The logic system may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. The apparatus may include a memory device. The interface may be an interface between the logic system and the memory device. Alternatively, or additionally, the interface may include a network interface.

The logic system may be capable of receiving a signal via the interface. The logic system may be capable of analyzing the signal to determine parameter values of an N-dimensional parameter set and for applying a first vector quantization process to two or more parameter values along a first dimension of the N-dimensional parameter set to produce a first set of quantized values. The logic system may be capable of calculating two or more parameter prediction values along a second dimension of the N-dimensional parameter set based, at least in part, on one or more values of the first set of quantized values, calculating prediction residual values based, at least in part, on the parameter prediction values and applying a second vector quantization process to the prediction residual values to produce a second set of quantized values.

The logic system may be further capable of determining a first vector quantization index corresponding to the first set of quantized values and for determining a second vector quantization index corresponding to the second set of quantized values. The first and second quantization indices may comprise pointers to data structure locations at which the first and second sets of quantized values, respectively, are stored.

The logic system may be further capable of performing the following operations: calculating two or more parameter prediction values along a k^{th} dimension of the N-dimensional parameter set, based at least in part on one or more values of one or more of (k−1) previously produced sets of quantized values; calculating prediction residual values based at least in part on the parameter prediction values along the k^{th} dimension; and applying a k^{th} vector quantization process to the prediction residual values along the k^{th} dimension to produce a k^{th} set of quantized values.

The logic system may be further capable of performing the following operations: determining a maximum vector quantizer length Mₖ for dimension k; determining that a number of values Vₖ to be vector quantized exceeds Mₖ; determining Vₖ−Mₖ remaining values to be vector quantized; predicting, based at least in part on at least one of the Mₖ quantized values, Vₖ−Mₖ parameter prediction values along the k^{th} dimension; calculating (Vₖ−Mₖ) k^{th} dimension prediction residual values; and performing a vector quantization process for the (Vₖ−Mₖ) k^{th} dimension prediction residual values to produce Vₖ−Mₖ quantized values of the k^{th} parameter set.

According to some implementations, an apparatus may include an interface and a logic system. The logic system may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. The apparatus may include a memory device. The interface may be an interface between the logic system and the memory device. Alternatively, or additionally, the interface may include a network interface.

The logic system may be capable of receiving a signal, via the interface, that includes first and second vector quantization indices. In some implementations, the signal may include encoded audio data. The logic system may be capable of performing a first inverse vector quantization operation in response to the first vector quantization index to reconstruct two or more parameter values along a first dimension of an N-dimensional parameter set. The logic system may be capable of determining two or more parameter prediction values of a second dimension of the N-dimensional parameter set based at least in part on one or more of the two or more parameter values of the first dimension of the N-dimensional parameter set.

The logic system may be capable of performing a second inverse vector quantization operation in response to the second vector quantization index to reconstruct two or more prediction residual values of the second dimension. The logic system may be capable of combining the parameter prediction values of the second dimension with the prediction residual values of the second dimension to reconstruct two or more parameter values of the second dimension.

The logic system also may be capable of performing the following operations: receiving, via the interface, a k^{th} vector quantization index; determining two or more parameter prediction values along a k^{th} dimension of the N-dimensional parameter set, based at least in part on one or more previously determined parameter values of a dimension less than k of the N-dimensional parameter set; performing a k^{th} inverse vector quantization operation in response to the k^{th} vector quantization index to reconstruct two or more prediction residual values of the k^{th} dimension; and combining the parameter prediction values of the k^{th} dimension with the prediction residual values of the k^{th} dimension to reconstruct two or more parameter values of the k^{th} dimension.

The logic system may be further capable of receiving an indication of a maximum vector quantizer length Mₖ for dimension k, of determining that a remaining number of parameter values Vₖ to be reconstructed along dimension k exceeds Mₖ and of reconstructing the first Mₖ values along dimension k based, at least in part, on the k^{th} quantization index. The logic system may be capable of determining, based at least in part on the k^{th} quantization index, Vₖ−Mₖ parameter prediction values of the k^{th} dimension. The logic system may be capable of receiving an additional vector quantization index for the k^{th} dimension and of performing an inverse vector quantization operation, in response to the additional vector quantization index for the k^{th} dimension, to reconstruct Vₖ−Mₖ prediction residual values of the k^{th} dimension. The logic system may be capable of combining the Vₖ-Mₖ prediction residual values of the k^{th} dimension with the Vₖ−Mₖ parameter prediction values of the k^{th} dimension to reconstruct the remaining Vₖ−Mₖ parameter values of the k^{th} dimension.

The first vector quantization index may correspond to a memory location of a first set of quantized values. The second vector quantization index may correspond to a memory location of a second set of quantized values. The logic system may be further capable of receiving parameter set partition information; and of implementing the performing and determining steps according to the parameter set partition information.

In some implementations, an apparatus may include an interface and a logic system configured for performing at least some of the other methods described herein. The logic system may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. The apparatus may include a memory device. In some implementations, the interface may be an interface between the logic system and the memory device. Alternatively, the interface may be a network interface.

Some aspects of this disclosure may be implemented via a non-transitory medium having software stored thereon. The software may include instructions for controlling at least one apparatus to perform the following operations: receive a signal; analyze the signal to determine parameter values of an N-dimensional parameter set; apply a first vector quantization process to two or more parameter values along a first dimension of the N-dimensional parameter set to produce a first set of quantized values; calculate two or more parameter prediction values along a second dimension of the N-dimensional parameter set based, at least in part, on one or more values of the first set of quantized values; calculate prediction residual values based, at least in part, on the parameter prediction values; and apply a second vector quantization process to the prediction residual values to produce a second set of quantized values.

The software may include instructions for controlling the at least one apparatus to determine a first vector quantization index corresponding to the first set of quantized values and to determine a second vector quantization index corresponding to the second set of quantized values. The first and second quantization indices may, for example, be pointers to data structure locations at which the first and second sets of quantized values, respectively, are stored.

The software may include instructions for controlling the at least one apparatus to perform the following operations: calculate two or more parameter prediction values along a k^{th} dimension of the N-dimensional parameter set, based at least in part on one or more values of one or more of (k−1) previously produced sets of quantized values; calculate prediction residual values based at least in part on the parameter prediction values along the k^{th} dimension; and apply a k^{th} vector quantization process to the prediction residual values along the k^{th} dimension, to produce a k^{th} set of quantized values.

The software may include instructions for controlling the at least one apparatus to do the following: determine a maximum vector quantizer length Mₖ for dimension k; determine that a number of values Vₖ to be vector quantized exceeds Mₖ; determine Vₖ−Mₖ remaining values to be vector quantized; predict, based at least in part on at least one of the Mₖ quantized values, Vₖ−Mₖ parameter prediction values along the k^{th} dimension; calculate (Vₖ−Mₖ) k^{th} dimension prediction residual values; and perform a vector quantization process for the (Vₖ−Mₖ) k^{th} dimension prediction residual values to produce Vₖ-Mₖ quantized values of the k^{th} parameter set.

Other aspects of this disclosure also may be implemented via a non-transitory medium having software stored thereon. The software may include instructions for controlling at least one apparatus to perform the following operations: receive a signal comprising first and second vector quantization indices; perform a first inverse vector quantization operation in response to the first vector quantization index to reconstruct two or more parameter values along a first dimension of an N-dimensional parameter set; determine two or more parameter prediction values of a second dimension of the N-dimensional parameter set based at least in part on one or more of the two or more parameter values of the first dimension of the N-dimensional parameter set; perform a second inverse vector quantization operation in response to the second vector quantization index to reconstruct two or more prediction residual values of the second dimension; and combine the parameter prediction values of the second dimension with the prediction residual values of the second dimension to reconstruct two or more parameter values of the second dimension. In some implementations, the signal may include encoded audio data.

The software may include instructions for controlling the at least one apparatus to perform the following operations: receive a k^{th} vector quantization index; determine two or more parameter prediction values along a k^{th} dimension of the N-dimensional parameter set, based at least in part on one or more previously determined parameter values of a dimension less than k of the N-dimensional parameter set; perform a k^{th} inverse vector quantization operation in response to the k^{th} vector quantization index to reconstruct two or more prediction residual values of the k^{th} dimension; and combine the parameter prediction values of the k^{th} dimension with the prediction residual values of the k^{th} dimension to reconstruct two or more parameter values of the k^{th} dimension.

The software may include instructions for controlling the at least one apparatus to do the following: receive an indication of a maximum vector quantizer length Mₖ for dimension k; determining that a remaining number of parameter values Vₖ to be reconstructed along dimension k exceeds Mₖ; reconstructing the first Mₖ values along dimension k based, at least in part, on the k^{th} quantization index; determining, based at least in part on the k^{th} quantization index, Vₖ−Mₖ parameter prediction values of the k^{th} dimension; receiving an additional vector quantization index for the k^{th} dimension; performing an inverse vector quantization operation, in response to the additional vector quantization index for the k^{th} dimension, to reconstruct Vₖ−Mₖ prediction residual values of the k^{th} dimension; and combining the Vₖ−Mₖ prediction residual values of the k^{th} dimension with the Vₖ−Mₖ parameter prediction values of the k^{th} dimension to reconstruct the remaining Vₖ−Mₖ parameter values of the k^{th} dimension.

In some implementations, the first vector quantization index may correspond to a memory location of a first set of quantized values and the second vector quantization index may correspond to a memory location of a second set of quantized values. The software may include instructions for controlling the at least one apparatus to receive parameter set partition information and to implement the performing and determining steps according to the parameter set partition information.

Other aspects of this disclosure also may be implemented in a non-transitory medium having software stored thereon. The software may include instructions to control one or more devices to perform at least some of the methods described herein.

Details of one or more implementations of the subject matter described in this specification are set forth in the accompanying drawings and the description below. Other features, aspects and advantages will become apparent from the description, the drawings and the claims. Note that the relative dimensions of the following figures may not be drawn to scale.

### BRIEF DESCRIPTION OF THE DRAWINGS

FIGS. 1A and 1B are graphs that show examples of channel coupling during an audio encoding process.

FIGS. 2A and 2B are vector diagrams that provide a simplified illustration of spatial parameters.

FIG. 3 is a graph of the joint probability density function (pdf) of the alphas of two channels when four channels are coupled together.

FIG. 4A is a graph of the probability density function (pdf) of the alphas of adjacent frequency bands of a channel.

FIG. 4B is a graph of the probability density function (pdf) of the differences between the alphas of frequency bands n+1 and n+2 and the alphas of frequency band n.

FIG. 5A is a flow diagram that outlines blocks of an encoding method that involves vector quantization.

FIG. 5B is a flow diagram that outlines blocks of an encoding method that extends the method of FIG. 5A to a k^{th} dimension.

FIG. 5C is a flow diagram that outlines blocks of an encoding method that involves a series of vector quantization operations in the same dimension.

FIG. 6 is a perspective diagram that provides an example of implementing a method according to FIG. 5 for a 3-dimensional parameter set.

FIG. 7A is a perspective diagram that depicts cells of a 3-dimensional array of parameters.

FIG. 7B is a perspective diagram that depicts cells of a 3-dimensional array of parameters at a different time from that corresponding with FIG. 7A.

FIG. 7C is a perspective diagram that depicts cells of a 3-dimensional array of parameters that has been partitioned.

FIG. 8A is a graph that shows an example of signal-to-noise ratio (“SNR”) versus bits per sample for inter-channel vector quantizers.

FIG. 8B is a graph that shows an example of SNR versus bits per sample for inter-band vector quantizers.

FIG. 9 is a parameter set diagram in which one of the dimensions corresponds to pairs of individual discrete channels.

FIG. 10A is a flow diagram that outlines blocks of a decoding method that involves inverse vector quantization.

FIG. 10B is a flow diagram that outlines blocks of a decoding method that extends the method of FIG. 10A to a k^{th} dimension.

FIG. 10C is a flow diagram that outlines blocks of a decoding method that involves a series of inverse vector quantization operations for the same dimension.

FIG. 11 is a block diagram that shows an example of how a decorrelator may be used in an audio processing system.

FIG. 12 is a block diagram that provides examples of components of an apparatus that may be configured for implementing aspects of the processes described herein.

Like reference numbers and designations in the various drawings indicate like elements.

### DESCRIPTION OF EXAMPLE EMBODIMENTS

The following description is directed to certain implementations for the purposes of describing some innovative aspects of this disclosure, as well as examples of contexts in which these innovative aspects may be implemented. However, the teachings herein can be applied in various different ways.

It is generally desirable to minimize the amount of data to be stored and/or transmitted. Encoding additional data may simplify the decoding process and/or provide greater functionality for the decoder, but at the cost of storing and/or transmitting additional encoded data. Therefore, there are many contexts in which efficient data encoding can provide benefit. Although the examples provided in this application are primarily described in terms of audio data, the concepts provided herein apply to other types of data, including but not limited to video data, image data, speech data, sensor signals (e.g., signals from temperature sensors, pressure sensors, gyroscopes, accelerometers), etc. Moreover, the described implementations may be embodied in various signal processing devices, including but not limited to encoders and/or decoders, which may be included in theater reproduction systems, mobile telephones, smartphones, desktop computers, hand-held or portable computers, netbooks, notebooks, smartbooks, tablets, stereo systems, televisions, set-top boxes, receivers, including but not limited to audio and audio-visual receivers, home theater systems, DVD players, digital recording devices and a variety of other devices. Accordingly, the teachings of this disclosure are not intended to be limited to the implementations shown in the figures and/or described herein, but instead have wide applicability.

Some audio codecs, including the AC-3 and E-AC-3 audio codecs (proprietary implementations of which are licensed as “Dolby Digital” and “Dolby Digital Plus”), employ some form of channel coupling to exploit redundancies between channels, encode data more efficiently and reduce the coding bit-rate. For example, with the AC-3 and E-AC-3 codecs, in a coupling channel frequency range beyond a specific “coupling-begin frequency,” the modified discrete cosine transform (MDCT) coefficients of the discrete channels (also referred to herein as “individual channels”) are downmixed to a mono channel, which may be referred to herein as a “composite channel” or a “coupling channel.” Some codecs may form two or more coupling channels.

The AC-3 and E-AC-3 decoders upmix the mono signal of the coupling channel into the discrete channels using scale factors based on coupling coordinates sent in the bitstream. In this manner, the decoder restores a high frequency envelope, but not the phase, of the audio data in the coupling channel frequency range of each channel.

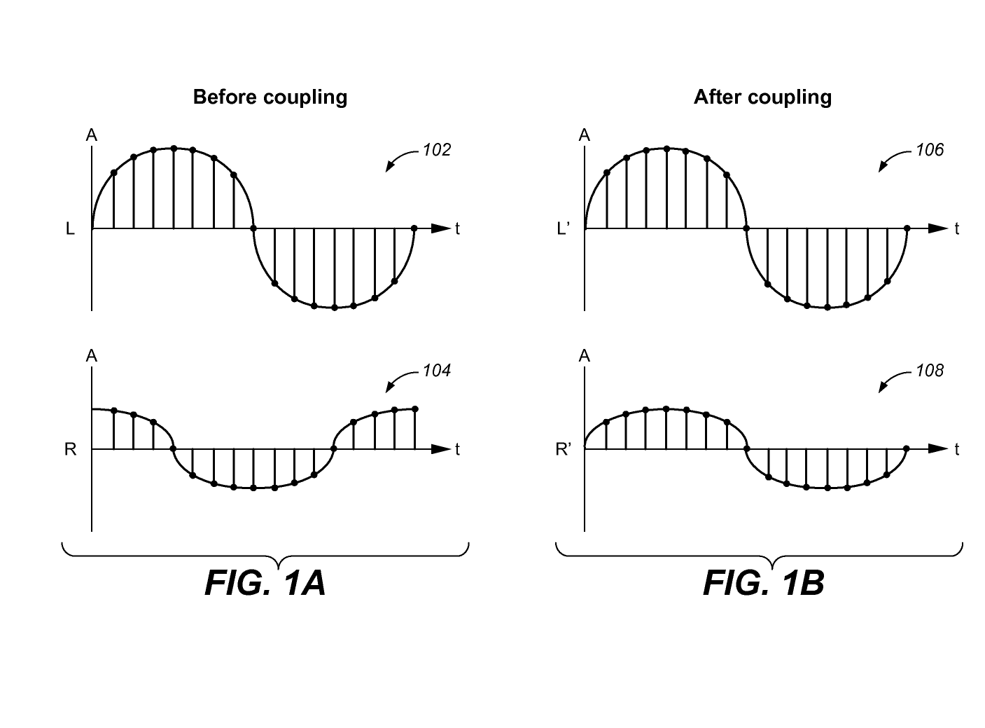

FIGS. 1A and 1B are graphs that show examples of channel coupling during an audio encoding process. Graph 102 of FIG. 1A indicates an audio signal that corresponds to a left channel before channel coupling. Graph 104 indicates an audio signal that corresponds to a right channel before channel coupling. FIG. 1B shows the left and right channels after encoding, including channel coupling and decoding. In this simplified example, graph 106 indicates that the audio data for the left channel is substantially unchanged, whereas graph 108 indicates that the audio data for the right channel is now in phase with the audio data for the left channel.

As shown in FIGS. 1A and 1B, the decoded signal beyond the coupling-begin frequency may be coherent between channels. Accordingly, the decoded signal beyond the coupling-begin frequency may sound spatially collapsed, as compared to the original signal. When the decoded channels are downmixed, for instance on binaural rendition via headphone virtualization or playback over stereo loudspeakers, the coupled channels may add up coherently. This may lead to a timbre mismatch when compared to the original reference signal. The negative effects of channel coupling may be particularly evident when multichannel decoded audio signals are binaurally rendered or downmixed for presentation over headphones and stereo loudspeakers.

Various implementations described herein may mitigate these effects, at least in part. Some such implementations involve novel audio encoding and/or decoding tools. For example, some such implementations may involve efficient encoding of parameters, such as spatial parameters, that may be used in a decorrelation process that can restore phase diversity of the output channels in frequency regions encoded by channel coupling.

Some audio processing systems described herein may be configured to determine one or more types of spatial parameters of audio data. Some such spatial parameters may be correlation coefficients between individual discrete channels and a coupling channel, which also may be referred to herein as “alphas.” Alphas also may be referred to herein as “mixing ratios.” For example, if the coupling channel includes audio data for four channels, there may be four alphas, one alpha for each channel. In some such implementations, the four channels may be the left channel (“L”), the right channel (“R”), the left surround channel (“Ls”) and the right surround channel (“Rs”). In some implementations, the coupling channel may include audio data for the above-described channels and a center channel. An alpha may or may not be calculated for the center channel, depending on whether the center channel will be decorrelated. Other implementations may involve a larger or smaller number of channels.

Other spatial parameters may be inter-channel correlation coefficients that indicate a correlation between pairs of individual discrete channels. Such parameters may sometimes be referred to herein as reflecting “inter-channel coherence” or “ICC.” In the four-channel example referenced above, there may be six ICC values involved, for the L-R pair, the L-Ls pair, the L-Rs pair, the R-Ls pair, the R-Rs pair and the Ls-Rs pair.

In some implementations, the determination of spatial parameters by a device (such as a decoder) may involve receiving explicit spatial parameters in a bitstream. Alternatively, or additionally, a device (such as an encoder or a decoder) may be configured to determine or to estimate at least some spatial parameters. Some devices may be configured to determine mixing parameters based, at least in part, on spatial parameters.

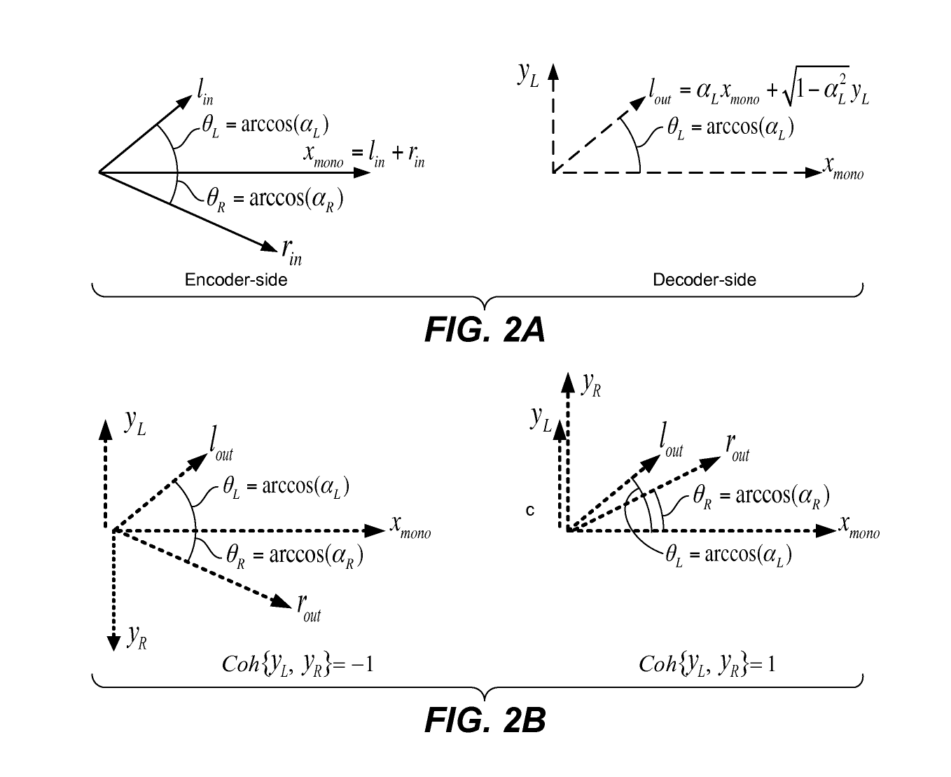

FIGS. 2A and 2B are vector diagrams that provide a simplified illustration of spatial parameters. FIGS. 2A and 2B may be considered a 3-dimensional conceptual representation of signals in a D-dimensional vector space. Each D-dimensional vector may represent a real- or complex-valued random variable whose D coordinates correspond to any D independent trials. For example, the D coordinates may correspond to a collection of D frequency-domain coefficients of a signal within a frequency range and/or within a time interval (e.g., during a few audio blocks).

Referring first to the left panel of FIG. 2A, this vector diagram represents the spatial relationships between a left input channel lᵢₙ, a right input channel rᵢₙ and a coupling channel xₘₒₙₒ, a mono downmix formed by summing lᵢₙ and rᵢₙ. FIG. 2A is a simplified example of forming a coupling channel, which may be performed by an encoding apparatus. The correlation coefficient between the left input channel lᵢₙ and the coupling channel xₘₒₙₒ is α_{L}, and correlation coefficient between the right input channel rᵢₙ and the coupling channel is α_{R}. Accordingly, the angle θ_{L} between the vectors representing the left input channel lᵢₙ and the coupling channel xₘₒₙₒ equals arccos(α_{L}) and the angle θ_{R} between the vectors representing the right input channel rᵢₙ and the coupling channel xₘₒₙₒ equals arccos(α_{R}).

The right panel of FIG. 2A shows a simplified example of decorrelating an individual output channel from a coupling channel. A decorrelation process of this type may be performed, for example, by a decoding apparatus. By generating a decorrelation signal y_{L} that is uncorrelated with (perpendicular to) to the coupling channel xₘₒₙₒ and mixing it with the coupling channel xₘₒₙₒ using proper weights, the amplitude of the individual output channel (lₒᵤₜ, in this example) and its angular separation from the coupling channel xₘₒₙₒ can accurately reflect the amplitude of the individual input channel and its spatial relationship with the coupling channel. The decorrelation signal y_{L} should have the same power distribution (represented here by vector length) as the coupling channel xₘₒₙₒ. In this example, lₒᵤₜ=α_{L}xₘₒₙₒ+\sqrt{1−α_{L}²}yL. By denoting \sqrt{1−α_{L}²}=β_{L}, lₒᵤₜ=α_{L} xₘₒₙₒ+β_{L}y_{L}.

However, restoring the spatial relationship between individual discrete channels and a coupling channel does not guarantee the restoration of the spatial relationships between the discrete channels (represented by the ICCs). This fact is illustrated in FIG. 2B. The two panels in FIG. 2B show two extreme cases. The separation between lₒᵤₜ and rₒᵤₜ is maximized when the decorrelation signals y_{L} and y_{R} are separated by 180°, as shown in the left panel of FIG. 2B. In this case, the ICC between the left and right channels is minimized and the phase diversity between lₒᵤₜ and rₒᵤₜ is maximized. Conversely, as shown in the right panel of FIG. 2B, the separation between lₒᵤₜ and rₒᵤₜ is minimized when the decorrelation signals y_{L} and y_{R} are separated by 0°. In this case, the ICC between the left and right channels is maximized and the phase diversity between lₒᵤₜ and rₒᵤₜ is minimized.

In the examples shown in FIG. 2B, all of the illustrated vectors are in the same plane. In other examples, y_{L} and y_{R} may be positioned at other angles with respect to each other. However, it is preferable that y_{L} and y_{R} are perpendicular, or at least substantially perpendicular, to the coupling channel xₘₒₙₒ. In some examples either y_{L} and y_{R} may extend, at least partially, into a plane that is orthogonal to the plane of FIG. 2B.

Because the discrete channels are ultimately reproduced and presented to listeners, proper restoration of the spatial relationships between discrete channels (the ICCs) may significantly improve the restoration of spatial characteristics of the audio data. As may be seen by the examples of FIG. 2B, an accurate restoration of the ICCs depends on creating decorrelation signals (here, y_{L} and y_{R}) that have proper spatial relationships with one another. This correlation between decorrelation signals may be referred to herein as the inter-decorrelation-signal coherence or “IDC.”

In the left panel of FIG. 2B, the IDC between y_{L} and y_{R} is −1. As noted above, this IDC corresponds with a minimum ICC between the left and right channels. By comparing the left panel of FIG. 2B with the left panel of FIG. 2A, it may be observed that in this example with two coupled channels, the spatial relationship between lₒᵤₜ and rₒᵤₜ accurately reflects the spatial relationship between lᵢₙ and rᵢₙ. In the right panel of FIG. 2B, the IDC between y_{L} and y_{R} is 1 (complete correlation). By comparing the right panel of FIG. 2B with the left panel of FIG. 2A, one may see that in this example the spatial relationship between lₒᵤₜ and rₒᵤₜ does not accurately reflect the spatial relationship between lᵢₙ and rᵢₙ.

Accordingly, by setting the IDC between spatially adjacent individual channels to −1, the ICC between these channels may be minimized and the spatial relationship between the channels may be closely restored when these channels are dominant. This results in an overall sound image that is perceptually approximate to the sound image of the original audio signal. Such methods may be referred to herein as “sign-flip” methods. In such methods, no knowledge of the actual ICCs is required.

Note, however, that such methods may still use the alpha parameters, and some methods may involve encoding these alpha parameters into a bitstream and transmitting the encoded parameters to a receiving device, such as a decoding device or a related device. The receiving device may use these alpha parameters, e.g., as an input to a decorrelation process. Other side information may be provided in a bitstream to a decoder, such as channel-specific scaling factors. For example, if the audio data has been encoded according to the AC-3 or E-AC-3 audio codecs, the scaling factors may be coupling coordinates or “cplcoords” that are encoded with the rest of the audio data. In alternate implementations, the ICCs may be derived at an encoder, coded and sent through a bitstream to a decoding device. Some such implementations may involve deriving the alpha parameters, if required, using the transmitted ICC parameters.

In some implementations, alphas may be transmitted at least once per frame, whereas in other implementations alphas may be transmitted as frequently as every block. In some implementations, a retransmission of alphas will occur whenever the coupling strategy changes. A retransmission of alphas generally implies a retransmission for all channels. Alphas are generally transmitted at the same frequency resolution as cplcoords and may be shared across frequency, e.g., as determined by the coupling band structure.

An encoder may calculate the alpha of a coupling band of a channel as the real part of the correlation coefficient between the complex (MDCT and MDST) transform coefficients of the channel and the complex transform coefficients of the coupling channel within the same band. This value may be averaged across blocks over which the alphas are shared and quantized. Further the encoder may employ a windowed calculation of alphas, where it may apply a window across frequency (e.g., on a consecutive set of frequency coefficients) centered in a particular band and tapering off to neighboring bands. The cross product of the windowed coefficients of a given channel and similarly windowed coefficients of the coupling channel may then be calculated to derive the correlation coefficient of the band.

Various implementations are described herein for efficiently encoding information, including but not limited to audio data. Some implementations involve exploiting the correlations between parameter values across various dimensions. In the example of audio data, some implementations may achieve relatively greater data encoding efficiencies by exploiting the correlations between parameter values across frequency bands, time intervals, channels and/or other dimensions. Some such correlations of parameters across dimensions will now be described in the context of audio data.

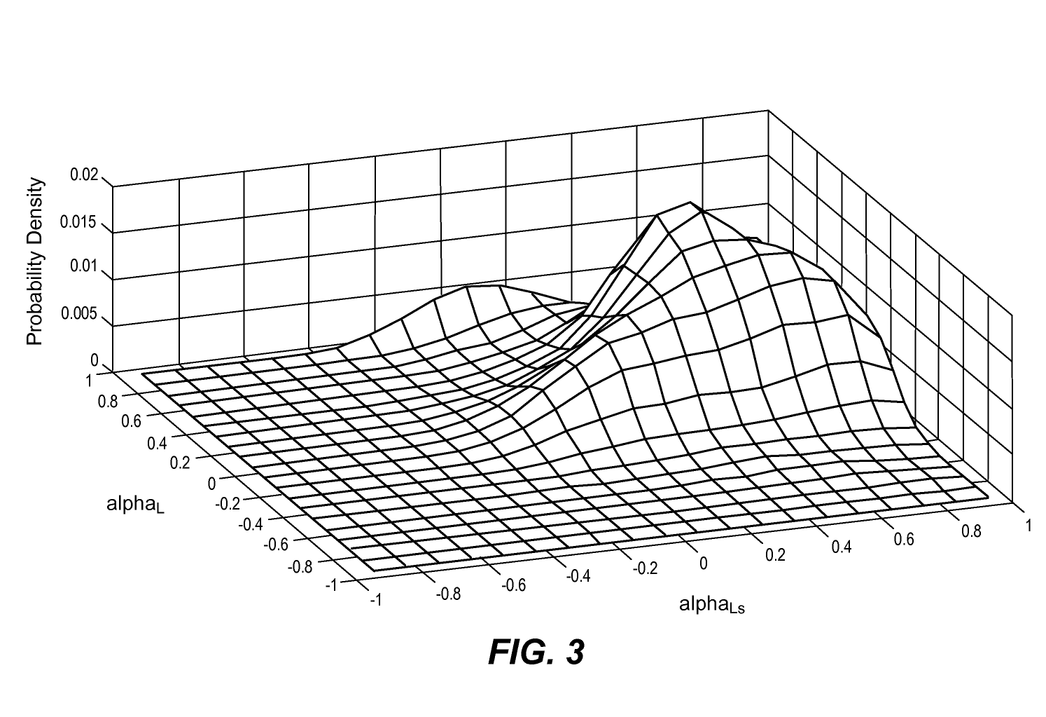

FIG. 3 is a graph of the joint probability density function (pdf) of the alphas of two channels when four channels are coupled together. In this example, the left (“L”), right (“R”), left surround (“Ls”) and right surround (“Rs”) channels are coupled. FIG. 3 indicates the joint pdf of the alphas of the L and Ls channels. In this example, the alpha values are in the range [−1 1].

As shown by the peak in FIG. 3, there is a correlation between the alphas of the L and Ls channels. The distribution is skewed towards the first quadrant (the range of alpha values between zero and one). This bias may be expected, because the coupling channel is a down-mix of individual channels and will likely have a positive correlation coefficient with a given channel if it is strong channel.

According to some implementations described herein, this correlation between alphas of different channels is exploited to gain coding efficiency. In some such implementations, coding efficiency may be enhanced by the use of a vector quantizer (“VQ”) to jointly quantize alphas of coupled channels.

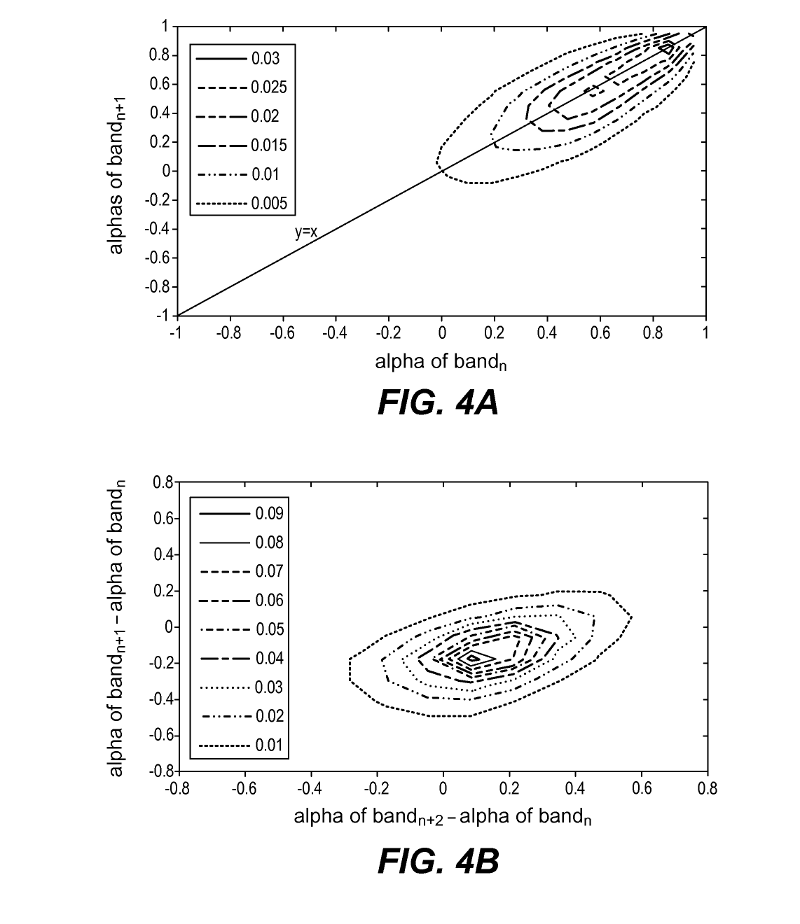

FIG. 4A is a graph of the probability density function (pdf) of the alphas of adjacent frequency bands of a channel. In this example, the channel is the L channel. The alphas of frequency band n are plotted on the horizontal axis and the alphas of frequency band n+1 are plotted on the vertical axis. The distribution is highly concentrated along the line y=x, which indicates a high degree of dependence between alphas of adjacent frequency bands. This dependence can be exploited in the quantization process for alphas via differential coding across frequency.

FIG. 4B is a graph of the probability density function (pdf) of the differences between the alphas of frequency bands n+1 and n+2 and the alphas of frequency band n. In this example, the differences between the alphas of frequency band n+1 and the alphas of frequency band n are plotted on the vertical axis. The differences between the alphas of frequency band n+2 and the alphas of frequency band n are plotted on the horizontal axis. By comparing FIGS. 4A and 4B, it is apparent that the correlation between these differences is not as great as the correlation between the alphas of frequency bands n+1 and n.

However, FIG. 4B nonetheless indicates that there is some degree of correlation, even if diminished. In order to exploit these correlations between alpha differences across frequency bands and to distribute bits efficiently over the small dynamic range of these differences, some implementations described herein involve an inter-band VQ for coding alpha differences across multiple frequency bands.

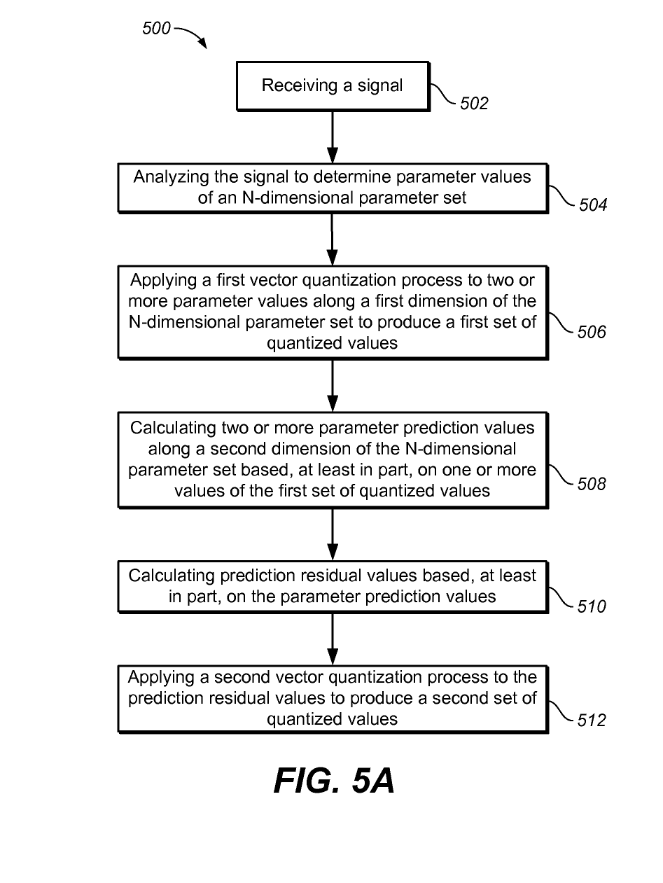

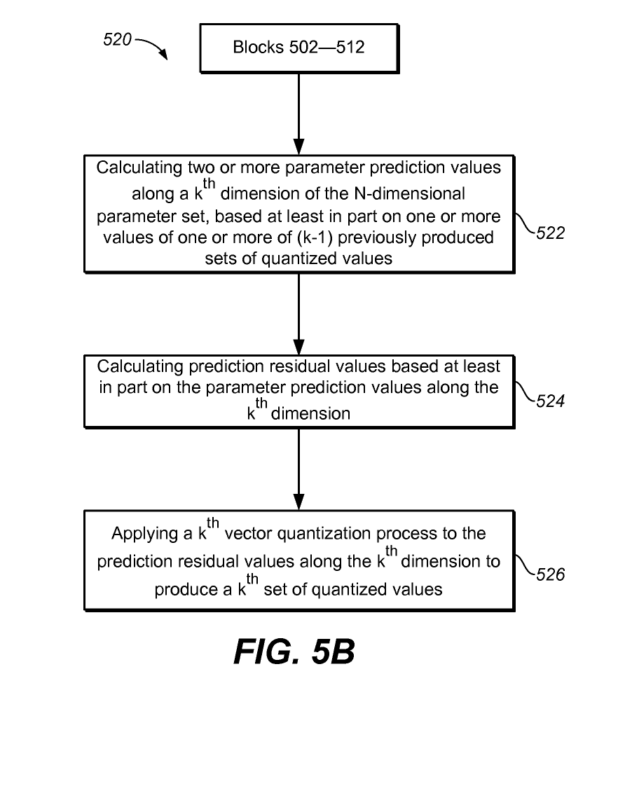

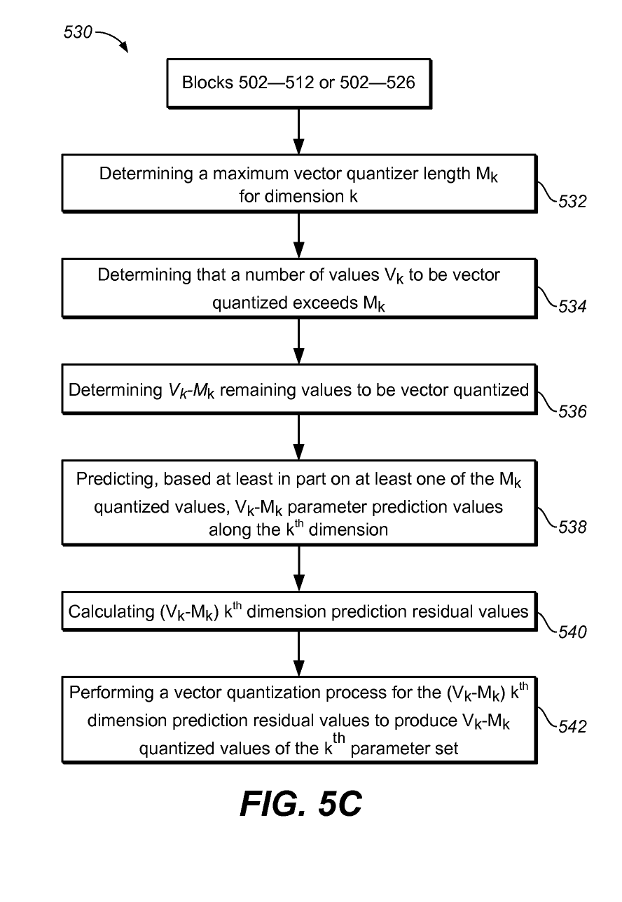

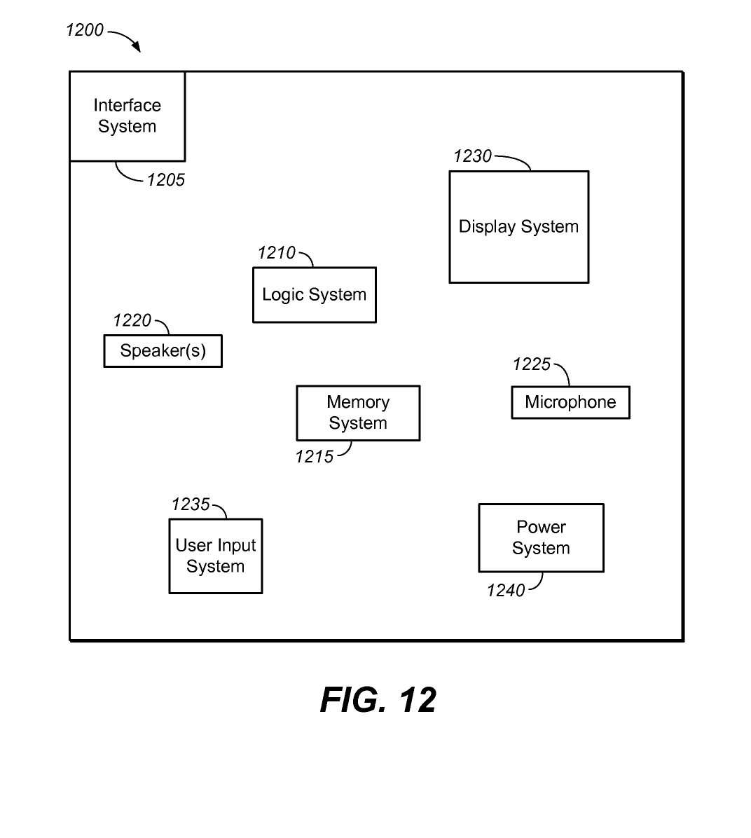

FIG. 5A is a flow diagram that outlines blocks of an encoding method that involves vector quantization. The operations of method 500, as with other methods described herein, are not necessarily performed in the order indicated. Moreover, these methods may include more or fewer blocks than shown and/or described. These methods may be implemented, at least in part, by a logic system such as the logic system 1210 shown in FIG. 12 and described below. Moreover, such methods may be implemented via a non-transitory medium having software stored thereon. The software may include instructions for controlling one or more devices to perform, at least in part, the methods described herein.

In this example, method 500 begins with block 502, in which a signal is received. For example, a signal may be received by a logic system of an encoding device in block 502. In this implementation, block 504 involves analyzing the signal to determine parameter values of an N-dimensional parameter set.

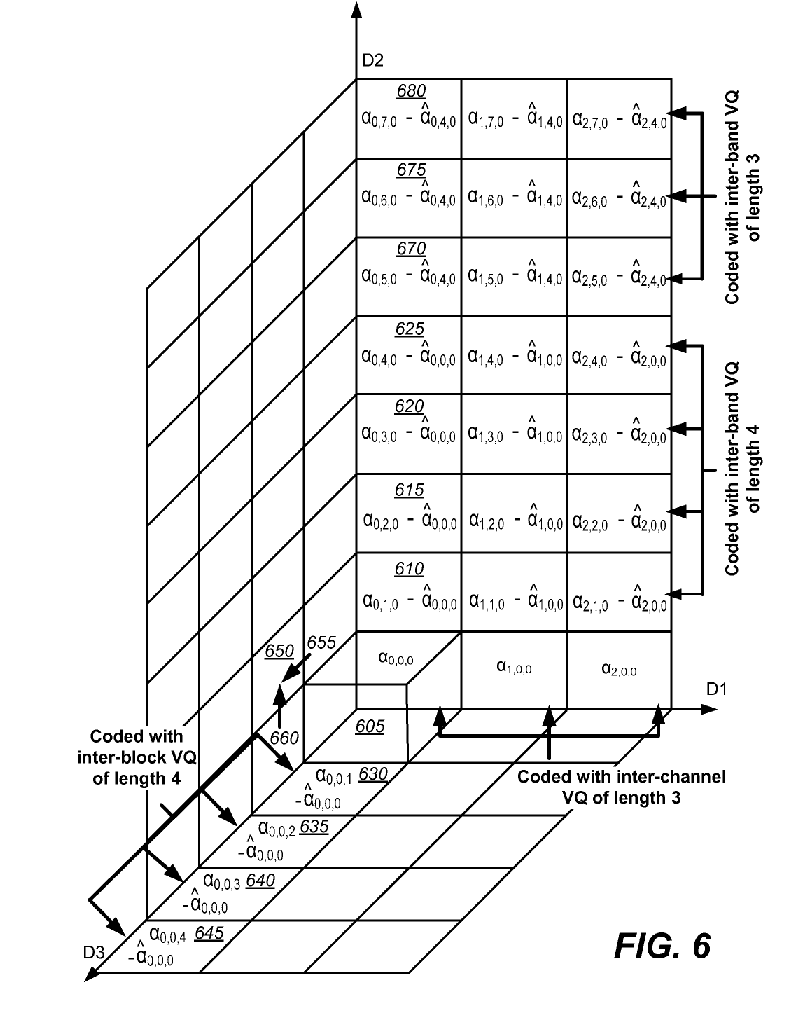

FIG. 6 is a perspective diagram that provides an example of implementing a method according to FIG. 5 for a 3-dimensional parameter set. In the example shown in FIG. 6, the signal received in block 502 includes audio data and the parameter values determined in block 502 are spatial parameter values, which are alpha values in this implementation. In this example, dimension one (“D1”) corresponds to channels, dimension two (“D2”) corresponds to frequency bands and dimension three (“D3”) corresponds to time blocks. In some implementations, the frequency bands may be coupling channel frequency bands.

In FIG. 6, cell 605 is depicted as a rectangular prism and corresponds to channel zero, band zero and block zero. The corresponding alpha value for each cell of FIG. 6 is denoted α_{i,k,t}, wherein i corresponds to a channel number, k corresponds to a frequency band number and t corresponds to a time block number. Accordingly, the alpha value for cell 605 is α_{0,0,0}. In order to simplify FIG. 6, not all of the alpha values are shown. Moreover, although each of the cells shown in FIG. 6 corresponds to a rectangular prism, only a single wall of the other cells is shown.

In block 506 of FIG. 5A, a first vector quantization process is applied to two or more parameter values along a first dimension of the N-dimensional parameter set, to produce a first set of quantized values. In the example shown in FIG. 6, the alpha values for frequency band zero and time block zero (α_{0,0,0}, α_{1,0,0} and α_{2,0,0}) may be encoded across channels, which is dimension D1. In this example, these alpha values may be encoded with an inter-channel VQ of length three.

Block 506 also may involve determining a first vector quantization index corresponding to the first set of quantized values. The first vector quantization index may, for example, be a pointer to a data structure location in which the first set of quantized values may be stored.

Block 508 may involve calculating two or more parameter prediction values along a second dimension of the N-dimensional parameter set based, at least in part, on one or more values of the first set of quantized values. In this example, the second dimension is D2, which corresponds to frequency bands, and the parameter prediction values for frequency bands 1 through 4 of channel zero (corresponding to cells 610, 615, 620 and 625) are the quantized value of α_{0,0,0} or \hat{α}_{0,0,0}. Similarly, the parameter prediction values for frequency bands 1 through 4 of channels one and two are the quantized values of α_{1,0,0} and α_{2,0,0}, respectively. Therefore, in this example, the parameter prediction values correspond to the first set of quantized values. However, in alternative implementations, the parameter prediction values may be derived from, but not identical to, the first set of quantized values.

In this example, block 510 involves calculating prediction residual values based, at least in part, on the parameter prediction values. Here, the prediction residual values are the differences between parameter value (the alpha value in this instance) for each cell and the parameter prediction value for that cell.

In this implementation, block 512 involves applying a second vector quantization process to the prediction residual values to produce a second set of quantized values. Block 512 also may involve determining a second vector quantization index corresponding to the second set of quantized values. The second vector quantization index may be a pointer to a data structure location in which the second set of quantized values are, or will be, stored. The data structure may be a codebook. In some implementations, a distortion metric may be used to design the quantizers for the VQ process (or in codebook search). For example, the distortion metric may be a mean squared error distortion metric. The VQ design process may partition a training set of vectors into clusters such that the sum of distances of each training vector from the centroid or average vector in the subset containing the training vector is minimized. Here the distance may be the distortion, as calculated by the distortion metric, incurred in approximating a training vector by the centroid of the subset it belongs to. In other words, the centroid of the subset may be the reconstruction of the training vectors in the subset.

In the example shown in FIG. 6, the second vector quantization process involves encoding the prediction residual values with an inter-band VQ of length four. Accordingly, the same parameter prediction value is used to calculate the prediction residual values for cells 610, 615, 620 and 625, as well as the corresponding cells of channels one and two. Method 500 (as well as the other encoding methods described herein) also may involve encoding data, including but not limited to the results of one or more of the indicated blocks. For example, method 500 may involve encoding the first and second quantization indices, VQ length information, etc.

The encoding process described above may be extended into any number of dimensions. FIG. 5B is a flow diagram that outlines blocks of an encoding method that extends the method of FIG. 5A to a k^{th} dimension. In this example, blocks 502-512 of method 500 have been performed before block 522 of method 520 commences.

Here, block 522 involves calculating two or more parameter prediction values along a k^{th} dimension of the N-dimensional parameter set, based at least in part on one or more values of one or more of (k−1) previously produced sets of quantized values. In this implementation, block 524 involves calculating prediction residual values based, at least in part, on the parameter prediction values along the k^{th} dimension.

In the example shown in FIG. 6, the k^{th} dimension is dimension D3, which corresponds to time blocks. Accordingly, block 522 may involve calculating parameter prediction values along the 3^{rd} dimension of the 3-dimensional parameter set, based at least in part on one or more previously produced sets of quantized values corresponding to the 1^{st} dimension and/or the 2^{nd} dimension. Therefore, block 522 may involve calculating parameter prediction values along a k^{th} dimension of the N-dimensional parameter set, based at least in part on one or more values of one or more of (k−1) previously produced sets of quantized values. Such quantized values may have been produced during a (k−1)^{th} stage of the method or during a prior stage. However, the k^{th} dimension does not necessarily correspond to the 3^{rd} dimension, but is intended to be a generalized way of referring to dimensions greater than 1.

Here, the parameter prediction value used for determining the prediction residual values for channel zero, frequency band zero is the quantized value of α_{0,0,0}. The prediction residual values for cells 630, 635, 640 and 645 are determined by subtracting the quantized value of α_{0,0,0} from the alpha value corresponding to each cell.

In this implementation, block 526 involves applying a k^{th} vector quantization process to the prediction residual values along the k^{th} dimension to produce a k^{th} set of quantized values. In the example shown in FIG. 6, a VQ of length four is used to encode the prediction residual values for cells 630, 635, 640 and 645. Method 520 also may involve determining and encoding a k^{th} quantization index corresponding to the k^{th} set of quantized values, corresponding VQ length information, etc.

Prediction residual values for other frequency bands and blocks may be determined in a similar fashion. Referring to FIG. 6, for example, corresponding processes may be used to vector quantize prediction residual values for the time blocks of channels 1 and 2. The prediction residual value for cell 650 may be determined according to values from the same frequency band, as suggested by arrow 655, and/or according to values from the same time block, as suggested by arrow 660. The prediction residual value for cell 650 may be determined according to values from the same frequency band but from a previous time block, as suggested by arrow 655: for instance, the prediction residual value for cell 650 could be the reconstruction of α_{0,1,0} of cell 610. Alternatively, the prediction residual value for cell 650 could be determined according to the values from the same time-block but from a different frequency band, as suggested by arrow 660: for instance, it could be the reconstruction of α_{0,0,1} of cell 630. Yet another approach may be to make the prediction residual value for cell 650 dependent on adjacent cells along both frequency and time axis, for instance, the prediction residual value for cell 650 may be a weighted combination, such as the average, of the reconstructions of α_{0,1,0} and α_{0,0,1}.

FIG. 5C is a flow diagram that outlines blocks of an encoding method that involves a series of vector quantization operations in the same dimension. In this example, at least blocks 502-512 of method 500, and possibly blocks 502-526, have been performed before block 532 of method 530.

Here, block 532 involves determining a maximum vector quantizer length Mₖ for dimension k. In some implementations, determining the maximum vector quantizer length Mₖ may involve receiving an indication of the maximum vector quantizer length Mₖ from a user, e.g., via a user interface. Alternatively, block 532 may involve retrieving the maximum vector quantizer length Mₖ from a memory. In some implementations, the maximum vector length Mₖ may be a variable that controls a bit rate for encoding parameters. Accordingly, the maximum vector length Mₖ may be based, at least in part, on an available bit rate for parameter encoding. In some implementations, this bit rate may vary over time. Another reason that the VQ length may be limited to a maximum Mₖ would be to constrain the amount of memory required to store the VQ codebooks, the tables of reconstructions corresponding to the VQs.

In this example, block 534 involves determining that a number of values Vₖ to be vector quantized exceed Mₖ and block 536 involves determining Vₖ−Mₖ remaining values to be vector quantized. Referring to FIG. 6, for example, one may observe that the values for frequency bands 1 through 4 (e.g., for cells 610, 615, 620 and 625) have been encoded with an inter-band VQ of length 4. In this example, length 4 corresponds with the maximum VQ length, so Mₖ is 4. (In other implementations, the maximum VQ length may be more or less than 4.) However, this VQ length is not sufficient for encoding values for all 7 of the frequency bands in this example: here, block 534 involves determining that Vₖ is 7, which exceeds 4, and block 536 involves determining that there are (Vₖ−Mₖ)=3 remaining values to be vector quantized.

In this implementation, block 538 involves predicting, based at least in part on at least one of the Mₖ quantized values, (Vₖ−Mₖ) parameter prediction values along the k^{th} dimension. In the example shown in FIG. 6, the three parameter prediction values for cells 670, 675 and 680 are the same value, which is the quantized value of α_{0,4,0}. In some instances, (Vₖ−Mₖ) may still be larger than Mₖ. In such instances, only Mₖ parameters may be quantized in a first operation and additional prediction residual values would remain to be quantized. The process may repeat until all Vₖ parameters along this dimension are quantized. Accordingly, in some implementations of the method 530, the number of remaining values to be vector quantized may be represented according to a modulo operator, e.g., as (Vₖ)_{mod}Mₖ. Multiple vectors of length Mₖ may be encoded prior to completing the process with the remaining (Vₖ)_{mod}Mₖ values.

Here, block 540 of FIG. 5C involves calculating (Vₖ−Mₖ) k^{th} dimension prediction residual values. Referring again to FIG. 6, the prediction residual values for cells 670, 675 and 680 are determined by subtracting the parameter prediction values from the alpha values for each cell.

In this implementation, block 542 involves performing a vector quantization process for the (Vₖ−Mₖ) k^{th} dimension prediction residual values to produce Vₖ-Mₖ quantized values of the k^{th} parameter set. In the example of FIG. 6, the prediction residual values for cells 670, 675 and 680 are vector quantized in block 542, using an inter-band VQ of length 3. Method 530 also may involve determining and encoding an additional quantization index for the k^{th} dimension corresponding to the Vₖ−Mₖ quantized values of the k^{th} parameter set, corresponding VQ length information, etc.

In some implementations, block 536 may involve determining that there is only one remaining parameter value to be quantized (Vₖ−Mₖ=1). In such implementations, the parameter value may be scalar quantized.

As noted above, various implementations provided herein involve providing an indication of VQ length with encoded signals. This may be necessary in cases where the VQ length is not fixed but instead is variable, for example, as a function of one or more of time, frequency, channel, etc.

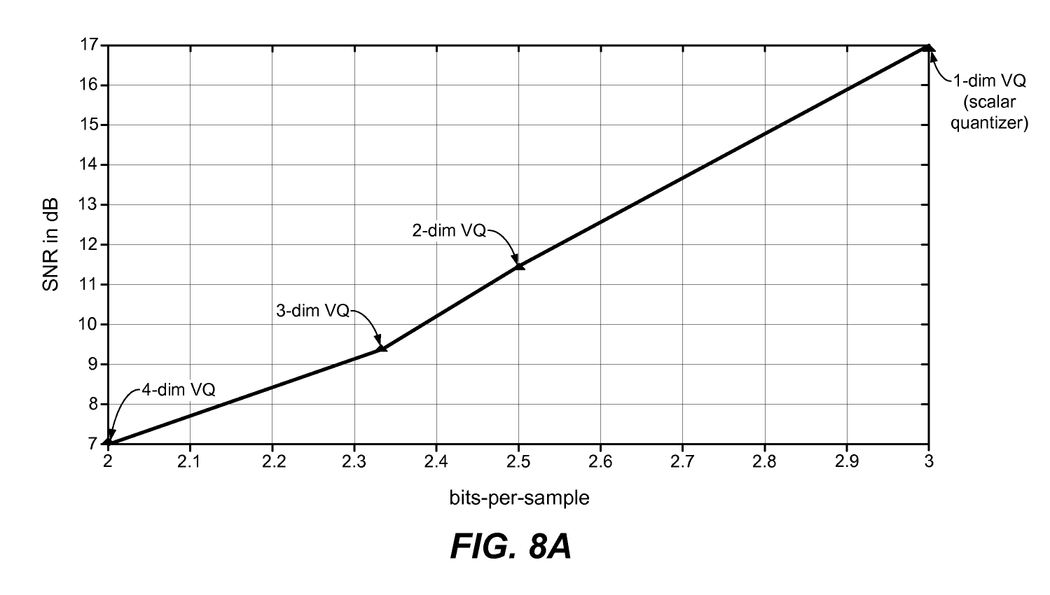

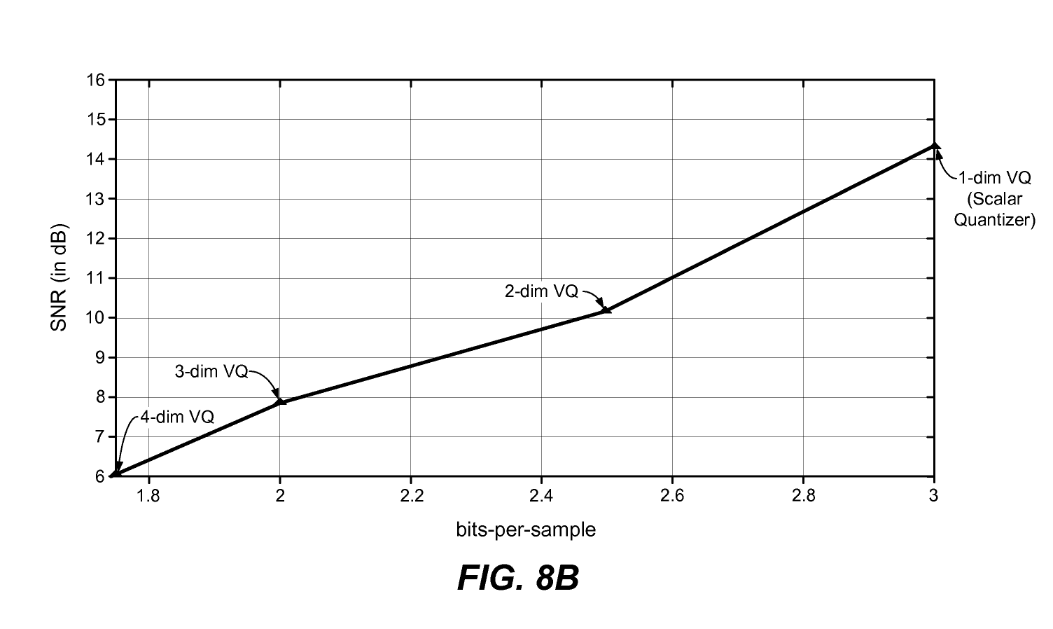

As a first example, in some implementations, the VQ length may be varied to control the bit-rate and resolution for parameter encoding. FIG. 8A is a graph that shows an example of SNR versus bits per sample for inter-channel VQs in one embodiment that involved the quantization of alphas. In this example, a scalar quantizer (which may be considered a VQ of length 1) requires 3 bits per sample and has a corresponding SNR value of 17 dB. Here, a VQ of length 4 requires only 2 bits per sample and has a corresponding SNR value of 7 dB.

FIG. 8B is a graph that shows an example of SNR versus bits per sample for inter-band VQs. In this example, a scalar quantizer requires 3 bits per sample and has a corresponding SNR value of about 14.3 dB and a VQ of length 2 requires about 2.5 bits per sample and a corresponding SNR or about 10 dB. However, a VQ of length 4 requires only 1.75 bits per sample and has a corresponding SNR value of about 6 dB. Thus, in this implementation, if parameters are to be encoded with better resolution (higher SNR) then a user may choose to reduce the maximum size of the VQ used for coding from, say, 4 to 2.

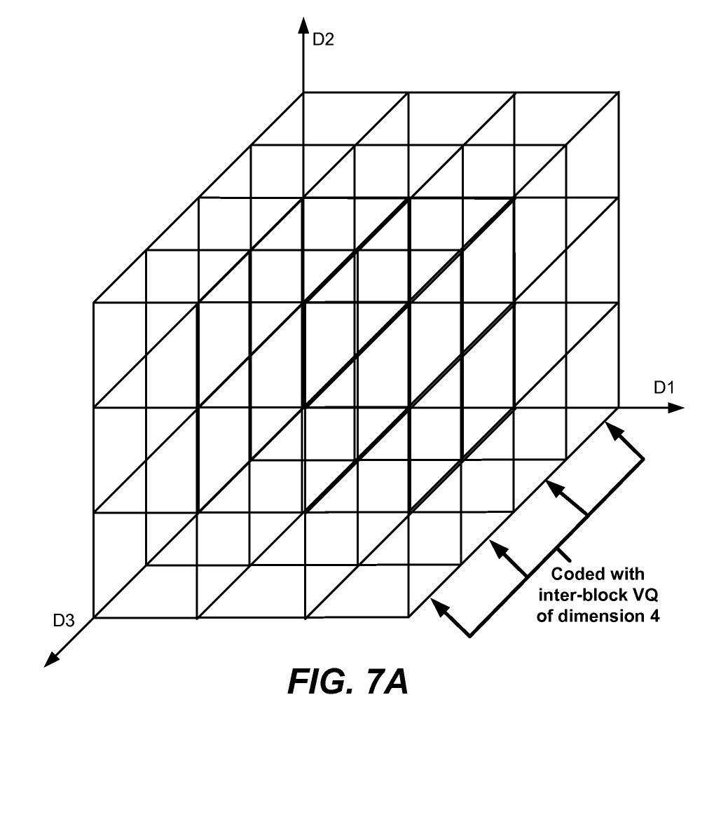

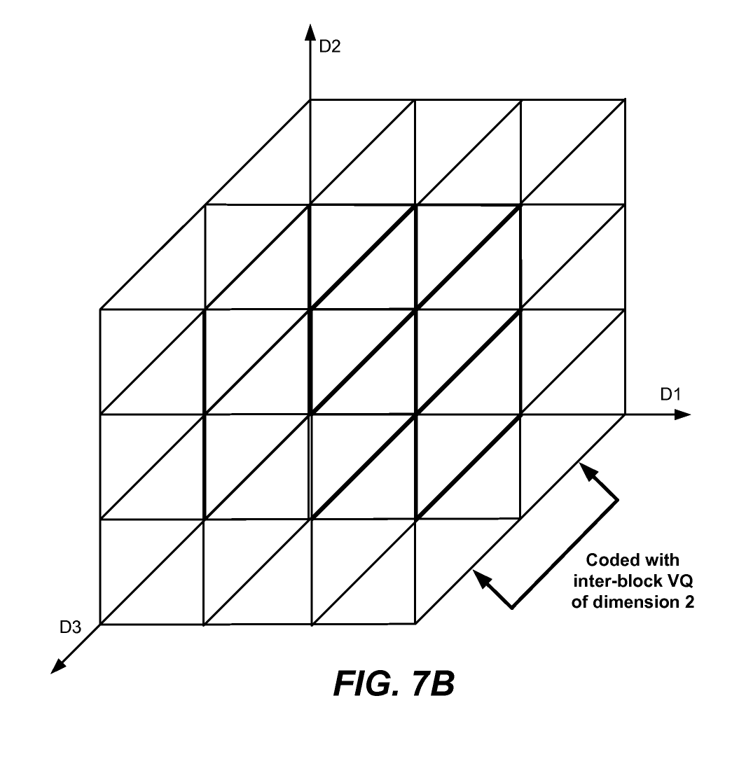

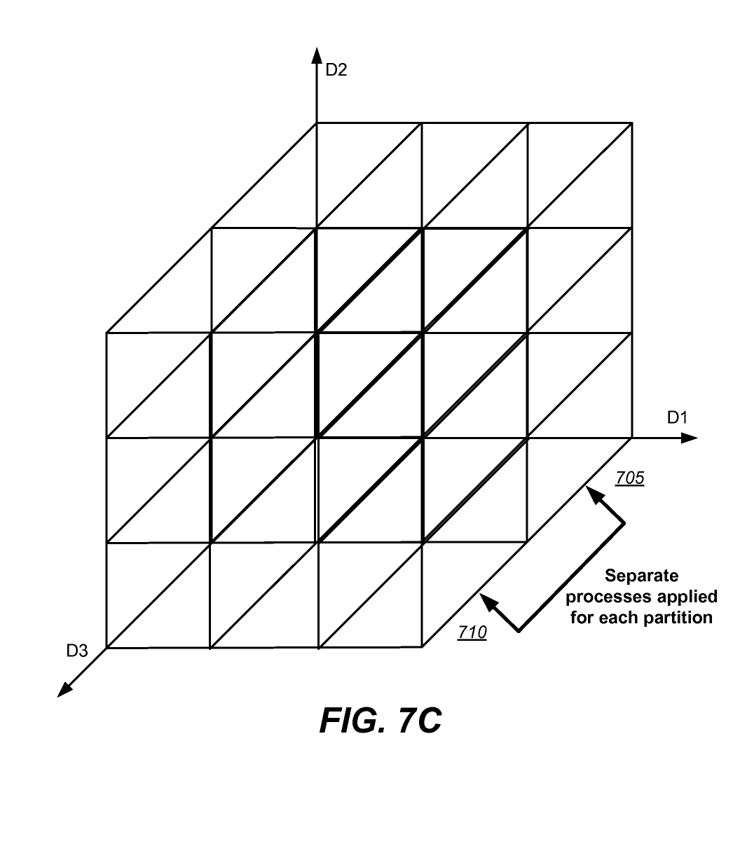

Furthermore, the VQ length could be varied based on considerations other than bit-rate as well. For example, signal characteristics could change over time, in response to which encoding decisions including the VQ length for parameter encoding may change. For instance, transients may occur at different times in different channels of an audio signal. Since typically only channels that do not have strong transients are coupled, the number and choice of channels in coupling can change from one time-block to the next, depending on which of them have transients. Each time such a coupling decision changes one may need to retransmit alpha parameters. Naturally an inter-channel VQ may need to be only of length 2 if 2 channels are in coupling, while it will be 3, if 3 channels are in coupling. Some other implementations will now be described with reference to FIGS. 7A and 7B.

FIG. 7A is a perspective diagram that depicts cells of a 3-dimensional array of parameters. At the time corresponding to FIG. 7A, parameter values of the third dimension (D3) are being coded with a VQ of dimension 4. In this example, the third dimension corresponds to time, so the VQ is an inter-block VQ of dimension 4.

FIG. 7B is a perspective diagram that depicts cells of a 3-dimensional array of parameters at a different time from that corresponding with FIG. 7A. At this time, parameter values of the third dimension are being coded with a VQ of dimension 2. In this example, the third dimension corresponds to time, so the VQ is an inter-block VQ of dimension 2. VQ length data corresponding to such changes may be encoded. A reason for using VQ lengths corresponding to different number of blocks in FIG. 7A and FIG. 7B may be that the signal characteristics were similar over 4 blocks during the time represented by FIG. 7A, whereas the signal characteristics were only similar for 2 blocks in the time represented by FIG. 7B.

In some implementations, a change similar to that depicted between FIGS. 7A and 7B may be caused by forming the parameter set into partitions of the parameter set. FIG. 7C is a perspective diagram that depicts cells of a 3-dimensional array of parameters that has been partitioned. In this example, parameter values along the third dimension have been partitioned into volumes 705 and 710. The partitioning process may vary with time. The partitioning process may, for example, be performed in a signal-adaptive manner. For example, the partitioning process may change according to the number of audio channels in coupling, according to whether parameter values are shared across time blocks, etc. Accordingly, partitioning indications may be expressly encoded and/or determined according to changes in related processes or parameters.

Moreover, in some implementations, at least some of the processes described above with reference to FIGS. 5A-5C may be performed separately for each partition of the parameter set. For example, in some implementations, the analyzing, applying and calculating processes of method 500 (see FIG. 5A) may be applied separately for volumes 705 and 710 of FIG. 7C.

Such partitioning may be advantageous, for example, to avoid exceeding a maximum VQ length for encoding parameter values corresponding to each of the volumes 705 and 710. For example, if the maximum VQ length is 3 and there are six parameter values to encode for each unit of data along dimension three (e.g., for each frame of data), it may be advantageous to partition the array along dimension three and group the parameter values into groups of 3.

Although FIG. 7C illustrates the results of a partitioning process along the third dimension, this is merely an example. Some implementations may involve partitioning along other dimensions. Some such implementations may involve simultaneously partitioning along multiple dimensions, e.g., along dimensions D3 and D1, along dimensions D1, D2 and D3, etc.

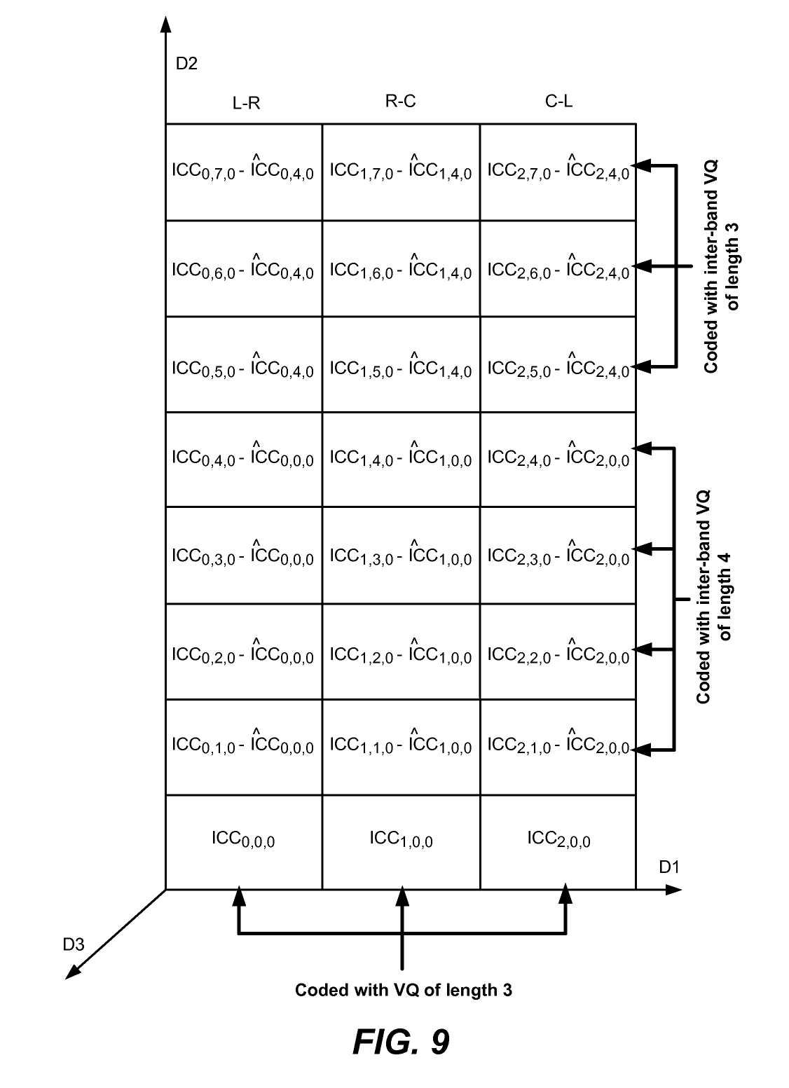

FIG. 9 is a parameter set diagram in which one of the dimensions corresponds to pairs of individual discrete channels. In this example, the dimension corresponding to pairs of individual discrete channels is the first dimension. Here, the pairs of individual discrete channels include an L-R channel pair, an R-C channel pair and a C-L channel pair. The channel pairs form a 3-channel-pair cycle, in this example, because each of the channel pairs includes a channel of the other channel pairs: the C-L channel pair may be conceptualized as linking back to the L-R channel pair. In this example, the parameter values are inter-channel correlation coefficients (“ICCs”) that indicate a correlation between the pairs of individual discrete channels.

These parameter values may be quantized as described above with reference to any of FIGS. 5A-5C. For example, the first vector quantization process may produce first quantized ICC values encoded with a VQ of length 3. The second vector quantization process may involve producing second quantized ICC values encoded with an inter-band VQ of length 4. The remaining ICC values may be encoded with an inter-band VQ of length 3.

In some implementations, a quantization process (e.g., the first vector quantization process) may involve quantizing a vector that includes ICCs of M−1 channel pairs in an Mₚ-channel-pair cycle, to produce quantized values of the M−1 ICCs. Referring to FIG. 9, for example, such a quantization process may involve encoding ICC values for two of the three channel pairs (e.g., the L-R and R-C channel pairs) with a VQ of length 2.

The quantization process also may involve calculating a range in which the Mₚ^{th} ICC lies based, at least in part, on the quantized values of the M−1 ICCs. Referring to FIG. 9, for example, this process may involve calculating a range in which the ICC for the C-L channel pair lies based, at least in part, on the quantized values of the L-R and R-C channel pairs. The quantization process also may involve quantizing the Mₚ^{th} ICC with a scalar quantizer, conditioned on the calculated range. Referring to FIG. 9, this process may involve quantizing the ICC for the C-L channel pair with a scalar quantizer, conditioned on the calculated range. For instance, in one extreme case, if ICCs for both L-R and R-C channel pairs have been quantized to 1, then the ICC for the C-L channel pair will also generally be close to 1. In this case there is no point having a scalar quantizer whose range spans the entire range in which an ICC can lie (in this example, [−1 1]). Instead, it may be sufficient if the ICC were to span a smaller range [a, 1], where “a” is a number close to 1 (e.g., 0.75). In this case, having the ICC span a smaller range [a, 1] has the advantage that better resolution can be achieved for the same number of bits spent on coding the C-L ICC.

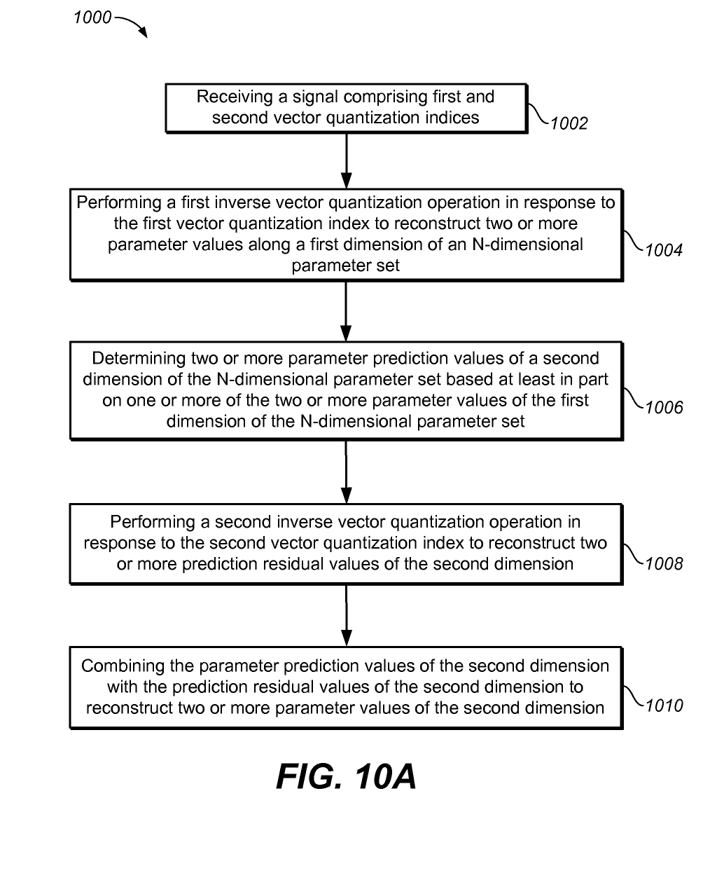

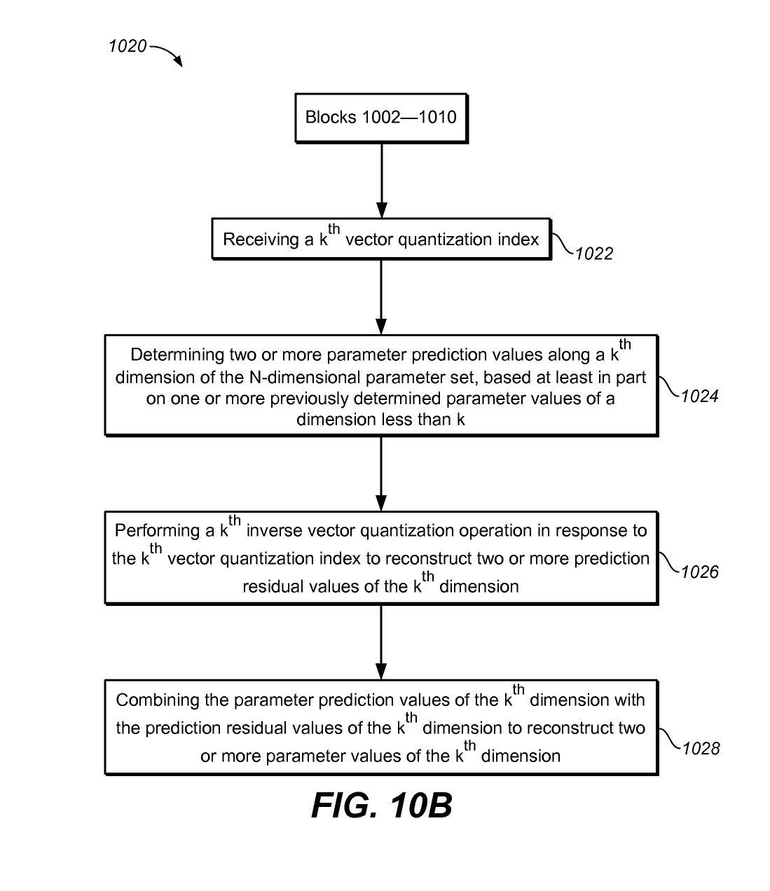

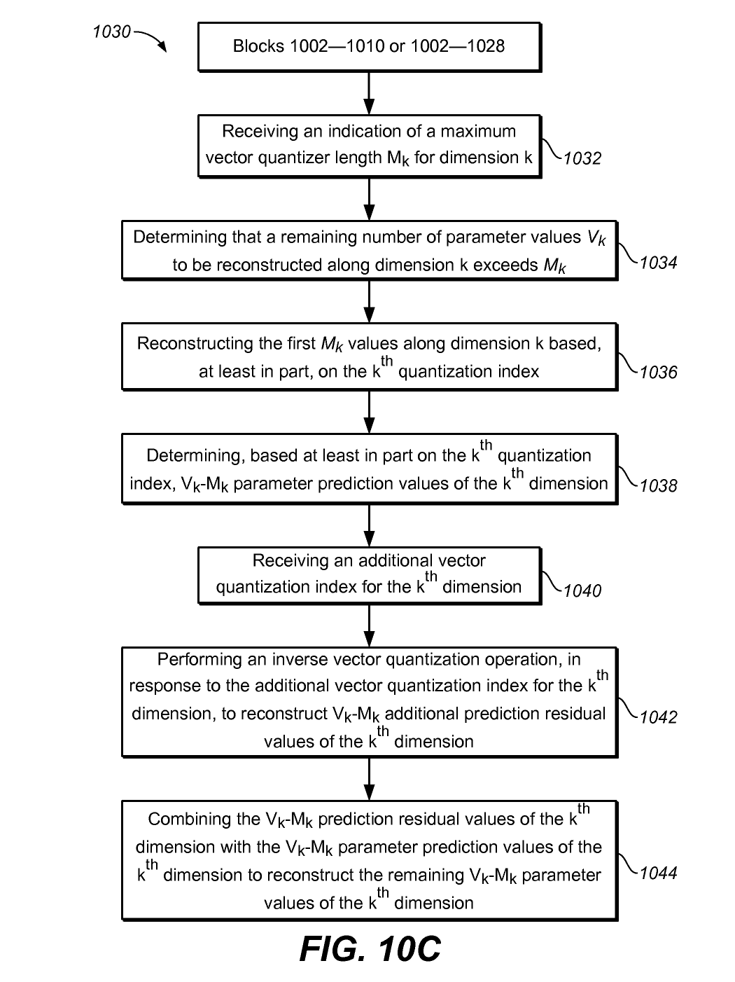

FIG. 10A is a flow diagram that outlines blocks of a decoding method that involves inverse vector quantization. The operations of method 1000 may be implemented, at least in part, by a logic system such as the logic system 1210 shown in FIG. 12 and described below.

Method 1000 may involve receiving signals that include data encoded according to methods described above. In this example, block 1002 of method 1000 involves receiving a signal that includes first and second vector quantization indices. The signal also may include other information, such as indications of VQ length, partitioning information, etc. In some implementations, the signal may include encoded audio data. The first and second quantization indices may, for example, include pointers to data structure locations at which the first and second sets of quantized values, respectively, are stored. The data structure locations may be locations in a codebook accessible by a decoding device, e.g., in a memory of a decoding device.

Here, block 1004 involves performing a first inverse vector quantization operation in response to the first vector quantization index to reconstruct two or more parameter values along a first dimension of an N-dimensional parameter set. In some implementations, the parameter values may be spatial parameter values. Referring to FIG. 6, for example, the parameter values may be quantized alpha values for frequency band zero and time block zero (α_{0,0,0}, α_{1,0,0} and α_{2,0,0}) that were encoded across channels, along dimension D1.

In this example, block 1006 involves determining two or more parameter prediction values of a second dimension of the N-dimensional parameter set based, at least in part, on one or more of the two or more parameter values of the first dimension of the N-dimensional parameter set. Referring again to FIG. 6, the parameter prediction values may be identical to the quantized alpha values for frequency band zero and time block zero in some implementations. In other implementations, the parameter prediction values may be based on, but not identical to, the quantized alpha values. In still other implementations, the parameter prediction values may be determined according to the first vector quantization index. For example, the parameter prediction values may be determined by performing an operation on values indicated by the first vector quantization index.

In this implementation, block 1008 involves performing a second inverse vector quantization operation in response to the second vector quantization index to reconstruct two or more prediction residual values of the second dimension. In various implementations described above, these prediction residual values were vector quantized, e.g., by an encoding device. The second vector quantization index may include a pointer to a data structure location at which the vector quantized prediction residual values of the second dimension may be found.

Referring again to FIG. 6, the second dimension may correspond to frequency bands. In some implementations, the frequency bands may include coupling channel frequency bands. The prediction residual values may correspond to the values indicated in cells 610, 615, 620 and 625, which are the differences between the parameter values corresponding to each cell (here, the alphas corresponding to each cell) and the parameter prediction value noted in each cell.

These prediction residual values, not the actual parameter values, are the output of block 1008 in this example. Accordingly, block 1010 involves combining the parameter prediction values of the second dimension with the prediction residual values of the second dimension to reconstruct two or more parameter values of the second dimension. In the example shown in FIG. 6, the alphas corresponding to four frequency bands of each channel may be determined in block 1010.

As noted above, some implementations may involve forming a parameter set into partitions, e.g., in a time-varying and/or signal-adaptive manner. Therefore, in some implementations block 1002 may involve receiving other information, such as parameter set partition information. Block 1002 also may involve receiving VQ length information. The processes of method 1000 (as well as other decoding methods described herein) may be performed, at least in part, according to the parameter set partition information and/or the VQ length information.

FIG. 10B is a flow diagram that outlines blocks of a decoding method that extends the method of FIG. 10A to a k^{th} dimension. Here, block 1022 involves receiving a k^{th} vector quantization index. In this example, blocks 1002-1012 of method 1000 have been performed before the process of block 1022 is performed.

In this implementation, block 1024 involves determining two or more parameter prediction values along a k^{th} dimension of the N-dimensional parameter set, based at least in part on one or more previously determined parameter values of a dimension less than k. In the example shown in FIG. 6, the k^{th} dimension is the third dimension, which corresponds to time. Accordingly, block 1024 may involve calculating parameter prediction values along the 3^{rd} dimension of the 3-dimensional parameter set, based at least in part on one or more previously produced sets of quantized values corresponding to the 1^{St} dimension and/or the 2^{nd} dimension. Therefore, the prediction of an alpha value for a k^{th} stage of method 1020 involves a reconstruction of an alpha value of a (k−1)′^{h} stage of the method (e.g., an alpha value determined according to method 1000). In the example of FIG. 6, the parameter prediction value for cells 630, 635, 640 and 645 along axis D3 is the quantized value of α_{0,0,0}.

In other implementations, the parameter prediction values may be based on, but not identical to, the quantized alpha values. In still other implementations, the parameter prediction values may be determined according to the first vector quantization index. For example, the parameter prediction values may be determined by performing an operation on values indicated by the first vector quantization index.

In this example, block 1026 of method 1000 involves performing a k^{th} inverse vector quantization operation in response to the k^{th} vector quantization index to reconstruct two or more prediction residual values of the k^{th} dimension. In the example of FIG. 6, the prediction residual values for cells 630, 635, 640 and 645 were previously determined by subtracting the quantized value of α_{0,0,0} from the alpha value corresponding to each cell. These prediction residual values were vector quantized with a VQ of length 4. In this example, the k^{th} vector quantization index includes a pointer to a data structure location at which these vector quantized are stored. Here, block 1026 involves an inverse vector quantization operation to reconstruct these prediction residual values.

In order to reconstruct the actual parameter values, method 1020 includes a further operation: here, block 1028 involves combining the parameter prediction values of the k^{th} dimension with the prediction residual values of the k^{th} dimension to reconstruct two or more parameter values of the k^{th} dimension. In the example of FIG. 6, the alpha values for cells 630, 635, 640 and 645 may be reconstructed in block 1028. Corresponding processes may be used to reconstruct alpha values for time blocks of channels 1 and 2.

In some implementations, alpha values may be shared across at least some adjacent time blocks. Accordingly, the alpha values for cells 630, 635, 640 and 645 may correspond to more than 4 time blocks. Moreover, in some implementations the dimensions may include pairs of individual discrete channels. The reconstructed parameter values may be inter-channel correlation coefficients (“ICCs”) that indicate a correlation between the pairs of individual discrete channels.

FIG. 10C is a flow diagram that outlines blocks of a decoding method that involves a series of inverse vector quantization operations for the same dimension. Here, block 1032 of method 1030 involves receiving an indication of a maximum vector quantizer length Mₖ for dimension k. In this example, at least blocks 1002-1010 of method 1000, and possibly blocks 1002-1028, have been performed before block 1032.

In this implementation, block 1034 involves determining that a remaining number of parameter values Vₖ to be reconstructed along dimension k exceeds Mₖ. Referring to FIG. 6, for example, block 1034 may involve determining that there are 7 alpha values to be reconstructed, corresponding to frequency bands 1 through 7, but that the maximum vector quantizer length for dimension 2 is 4.

Here, block 1036 involves reconstructing the first Mₖ values along dimension k based, at least in part, on the k^{th} quantization index. In the example shown in FIG. 6, block 1036 may involve reconstructing the first 4 values along dimension 2 based, at least in part, on the 2^{nd} quantization index, e.g., as described above.

In this example, block 1038 involves determining, based at least in part on the k^{th} quantization index, Vₖ−Mₖ parameter prediction values of the k^{th} dimension. In the example of FIG. 6, the parameter prediction values for the remaining 3 frequency bands (here, cells 670, 675 and 680) are determined from the reconstructed parameter value corresponding to cell 625, which as described above is derived based on the k^{th} quantization index. Specifically, all 3 of the parameter prediction values are equal to the reconstructed parameter value corresponding to cell 625 (here, the quantized value of α_{0,4,0}).

In block 1040, an additional vector quantization index for the k^{th} dimension is received. In this example, the additional vector quantization index corresponds to the prediction residual values for cells 670, 675 and 680.

In block 1042, an inverse vector quantization operation is performed in response to the additional vector quantization index for the k^{th} dimension to reconstruct Vₖ−Mₖ additional prediction residual values of the k^{th} dimension. In this example, the inverse vector quantization operation reconstructs the prediction residual values corresponding to cells 670, 675 and 680.

Here, block 1044 involves combining the Vₖ−Mₖ prediction residual values of the k^{th} dimension obtained in block 1042 with the Vₖ−Mₖ parameter prediction values of the k^{th} dimension obtained in block 1038 to reconstruct the remaining Vₖ−Mₖ parameter values of the k^{th} dimension. In the example of FIG. 6, the values of α_{0,5,0}, α_{0,6,0} and α_{0,7,0} may be reconstructed in block 1044.

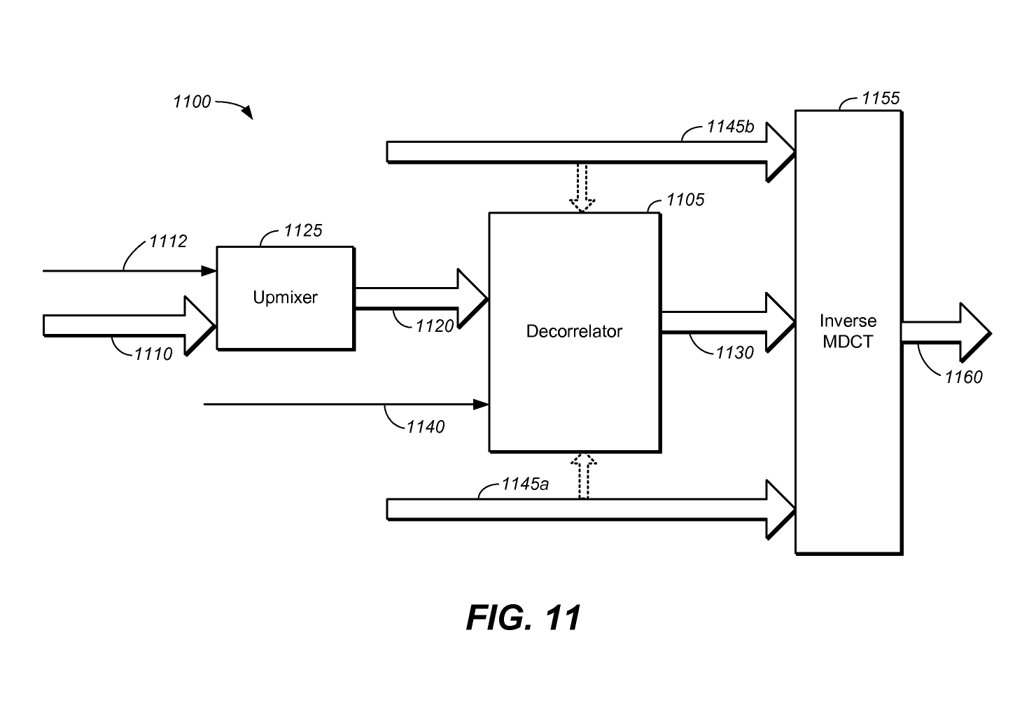

FIG. 11 is a block diagram that shows an example of how a decorrelator may be used in an audio processing system. In this example, the audio processing system 1100 is a decoder that includes a decorrelator 1105. In some implementations, the decoder may be configured to function according to the AC-3 or the E-AC-3 audio codec. However, in some implementations the audio processing system may be configured for processing audio data for other audio codecs.

The audio processing system 1100 may be configured to perform methods such as those that are described above, e.g., with reference to FIGS. 10A-10C. In some implementations, the output of such methods may be used as input for decorrelation processes. For example, spatial parameters that have been vector quantized by an encoding device may be received and reconstructed by the audio processing system 1100. Such spatial parameters may be used as input for some decorrelation processes.

In this example, an upmixer 1125 receives audio data 1110, which includes frequency domain representations of audio data of a coupling channel. The frequency domain representations are MDCT coefficients in this example.

The upmixer 1125 also receives coupling coordinates 1112 for each channel and coupling channel frequency range. In this implementation, scaling information, in the form of coupling coordinates 1112, has been computed in a Dolby Digital or Dolby Digital Plus encoder in an exponent-mantissa form. The upmixer 1125 may compute frequency coefficients for each output channel by multiplying the coupling channel frequency coordinates by the coupling coordinates for that channel.

In this implementation, the upmixer 1125 outputs decoupled MDCT coefficients of individual channels in the coupling channel frequency range to the decorrelator 1105. Accordingly, in this example the audio data 1120 that are input to the decorrelator 1105 include MDCT coefficients.

In the example shown in FIG. 11, the decorrelated audio data 1130 output by the decorrelator 1105 include decorrelated MDCT coefficients. In this example, not all of the audio data received by the audio processing system 1100 are also decorrelated by the decorrelator 1105. For example, the frequency domain representations of audio data 1145a, for frequencies below the coupling channel frequency range, as well as the frequency domain representations of audio data 1145b, for frequencies above the coupling channel frequency range, are not decorrelated by the decorrelator 1105. These data, along with the decorrelated MDCT coefficients 1130 that are output from the decorrelator 1105, are input to an inverse MDCT process 1155. In this example, the audio data 1145b include MDCT coefficients determined by the Spectral Extension tool, an audio bandwidth extension tool of the E-AC-3 audio codec.

In this example, decorrelation information 1140 is received by the decorrelator 1105. The type of decorrelation information 1140 received may vary according to the implementation. In some implementations, the decorrelation information 1140 may include explicit, decorrelator-specific control information and/or explicit information that may form the basis of such control information. The decorrelation information 1140 may, for example, include spatial parameters such as correlation coefficients between individual discrete channels and a coupling channel and/or correlation coefficients between individual discrete channels. Such explicit decorrelation information 1140 also may include explicit tonality information and/or transient information. This information may be used to determine, at least in part, decorrelation filter parameters for the decorrelator 1105.

However, in alternative implementations, no such explicit decorrelation information 1140 is received by the decorrelator 1105. According to some such implementations, the decorrelation information 1140 may include information from a bitstream of a legacy audio codec. For example, the decorrelation information 1140 may include time segmentation information that is available in a bitstream encoded according to the AC-3 audio codec or the E-AC-3 audio codec. The decorrelation information 1140 may include coupling-in-use information, block-switching information, exponent information, exponent strategy information, etc. Such information may have been received by an audio processing system in a bitstream along with audio data 1110.

In some implementations, the decorrelator 1105 (or another element of the audio processing system 1100) may determine spatial parameters, tonality information and/or transient information based on one or more attributes of the audio data. For example, the audio processing system 1100 may determine spatial parameters for frequencies in the coupling channel frequency range based on the audio data 1145a or 1145b, outside of the coupling channel frequency range. Alternatively, or additionally, the audio processing system 1100 may determine tonality information based on information from a bitstream of a legacy audio codec.

FIG. 12 is a block diagram that provides examples of components of an apparatus that may be configured for implementing aspects of the processes described herein. The device 1200 may be a mobile telephone, a smartphone, a desktop computer, a hand-held or portable computer, a netbook, a notebook, a smartbook, a tablet, a stereo system, a television, a DVD player, a digital recording device, or any of a variety of other devices. The device 1200 may include an encoding tool and/or a decoding tool. However, the components illustrated in FIG. 12 are merely examples. A particular device may be configured to implement various embodiments described herein, but may or may not include all components. For example, some implementations may not include a speaker or a microphone.

In this example, the device includes an interface system 1205. The interface system 1205 may include a network interface, such as a wireless network interface. Alternatively, or additionally, the interface system 1205 may include a universal serial bus (USB) interface or another such interface.

The device 1200 includes a logic system 1210. The logic system 1210 may include a processor, such as a general purpose single- or multi-chip processor. The logic system 1210 may include a digital signal processor (DSP), an application specific integrated circuit (ASIC), a field programmable gate array (FPGA) or other programmable logic device, discrete gate or transistor logic, or discrete hardware components, or combinations thereof. The logic system 1210 may be configured to control the other components of the device 1200. Although no interfaces between the components of the device 1200 are shown in FIG. 12, the logic system 1210 may be configured for communication with the other components. The other components may or may not be configured for communication with one another, as appropriate.

The logic system 1210 may be configured to perform various types of audio processing functionality, such as encoder and/or decoder functionality. Such encoder and/or decoder functionality may include, but is not limited to, the types of encoder and/or decoder functionality described herein. For example, the logic system 1210 may be configured to provide the vector quantization, partitioning, encoding, decoding, inverse vector quantization and/or decorrelator-related functionality described herein. In some such implementations, the logic system 1210 may be configured to operate (at least in part) according to software stored on one or more non-transitory media. The non-transitory media may include memory associated with the logic system 1210, such as random access memory (RAM) and/or read-only memory (ROM). The non-transitory media may include memory of the memory system 1215. The memory system 1215 may include one or more suitable types of non-transitory storage media, such as flash memory, a hard drive, etc.

For example, the logic system 1210 may be configured to receive frames of encoded audio data via the interface system 1205 and to decode the encoded audio data according to the methods described herein. Alternatively, or additionally, the logic system 1210 may be configured to receive frames of encoded audio data via an interface between the memory system 1215 and the logic system 1210. The logic system 1210 may be configured to control the speaker(s) 1220 according to decoded audio data. In some implementations, the logic system 1210 may be configured to encode audio data according to conventional encoding methods and/or according to encoding methods described herein. The logic system 1210 may be configured to receive such audio data via the microphone 1225, via the interface system 1205, etc.

The display system 1230 may include one or more suitable types of display, depending on the manifestation of the device 1200. For example, the display system 1230 may include a liquid crystal display, a plasma display, a bistable display, etc.

The user input system 1235 may include one or more devices configured to accept input from a user. In some implementations, the user input system 1235 may include a touch screen that overlays a display of the display system 1230. The user input system 1235 may include buttons, a keyboard, switches, etc. In some implementations, the user input system 1235 may include the microphone 1225: a user may provide voice commands for the device 1200 via the microphone 1225. The logic system may be configured for speech recognition and for controlling at least some operations of the device 1200 according to such voice commands.

The power system 1240 may include one or more suitable energy storage devices, such as a nickel-cadmium battery or a lithium-ion battery. The power system 1240 may be configured to receive power from an electrical outlet.

Various modifications to the implementations described in this disclosure may be readily apparent to those having ordinary skill in the art. The general principles defined herein may be applied to other implementations without departing from the spirit or scope of this disclosure. For example, while various implementations have been described in terms of Dolby Digital and Dolby Digital Plus, the methods described herein may be implemented in conjunction with other audio codecs. Moreover, the vector quantization and inverse quantization methods described herein are not limited to audio data applications, but have broad applicability.

For example, consider the motion vectors of a multi-view video sequence. Each motion vector may include a pair of parameters that represents the displacements in x and y directions for a small block of an image from one video frame to the next. Further, each view may have a motion vector for each such block in the view. Since a video object could be present in multiple views, the associated motion vectors may be correlated across views. Thus each displacement parameter may be indexed by two dimensions: one dimension may indicate the view and the second dimension may indicate whether the displacement is in the x direction or the y-direction. The displacement along x and y directions (e.g., the motion vector) in a single view may first be vector quantized. The motion vectors of adjacent views may then be predicted from the motion vectors of the first view. The prediction residual values of multiple views along a single position (x or y) may be jointly vector quantized.

The methods disclosed herein also may be applied to signal processing applications. For example, consider a grid of electronic sensors that are configured to respond to temperature variations. Thus, temperature is a parameter that can be extracted from the electrical signals (possibly digitized) provided by these sensors. The temperature parameter can thus be indexed by the sensor number in the grid and possibly by the time of sampling. Therefore the temperature parameter may have at least two dimensions. The parameter could be extracted and compressed for storage and use at a later time, or for transmission to a processing center on a channel of restricted bandwidth. Such data compression may involve quantization of the parameters. Temperatures from multiple sensors at a given time may be jointly vector quantized. The temperature of each sensor in subsequent instances of time may be predicted from the quantized temperature of the instant already considered. The prediction residuals across time may be grouped and vector quantized again.

Thus, the claims are not intended to be limited to the implementations shown herein, but are to be accorded the widest scope consistent with this disclosure, the principles and the novel features disclosed herein.

What is claimed is:

1. A method, comprising:
receiving a signal;
analyzing the signal to determine parameter values of an N-dimensional parameter set;
applying a first vector quantization process to two or more parameter values along a first dimension of the N-dimensional parameter set to produce a first set of quantized values;
calculating two or more parameter prediction values along a second dimension of the N-dimensional parameter set based, at least in part, on one or more values of the first set of quantized values;
calculating prediction residual values based, at least in part, on the parameter prediction values; and
applying a second vector quantization process to the prediction residual values to produce a second set of quantized values.

2. The method of claim 1, further comprising:
determining a first vector quantization index corresponding to the first set of quantized values; and
determining a second vector quantization index corresponding to the second set of quantized values.

3. The method of claim 2, wherein the first and second quantization indices comprise pointers to data structure locations at which the first and second sets of quantized values, respectively, are stored.

4. The method of any one of claims 1-3, further comprising:
calculating two or more parameter prediction values along a k^{th} dimension of the N-dimensional parameter set, based at least in part on one or more values of one or more of (k−1) previously produced sets of quantized values;
calculating prediction residual values based at least in part on the parameter prediction values along the k^{th} dimension; and
applying a k^{th} vector quantization process to the prediction residual values along the k^{th} dimension to produce a k^{th} set of quantized values.

5. The method of any one of claims 1-4, further comprising:
determining a maximum vector quantizer length Mₖ for dimension k;
determining that a number of values Vₖ to be vector quantized exceeds Mₖ;
determining Vₖ−Mₖ remaining values to be vector quantized;
predicting, based at least in part on at least one of the Mₖ quantized values, Vₖ−Mₖ parameter prediction values along the k^{th} dimension;
calculating (Vₖ−Mₖ) k^{th} dimension prediction residual values; and
performing a vector quantization process for the (Vₖ−Mₖ) k^{th} dimension prediction residual values to produce Vₖ−Mₖ quantized values of the k^{th} parameter set.

6. The method of claim 5, wherein determining the maximum vector quantizer length Mₖ involves receiving an indication of the maximum vector quantizer length Mₖ from a user.

7. The method of claim 6, wherein the maximum vector length Mₖ:
is a variable that controls a bit-rate for encoding parameters, and
is determined based on an available bit-rate for parameter encoding.

8. The method of any one of claims 1-7, further comprising forming the parameter set into partitions of the parameter set in a signal-adaptive manner.

9. The method of claim 8, wherein the analyzing, applying and calculating processes are applied separately on each partition of the parameter set.

10. The method of claim 8, wherein the forming process varies in time.

11. The method of any one of claims 1-10, wherein the signal comprises audio data.

12. The method of claim 11, wherein the dimensions include channels and frequency bands.

13. The method of claim 12, wherein the dimensions include time blocks.

14. The method of claim 12 or claim 13, wherein the parameter values comprise spatial parameter values.

15. The method of claim 14, wherein the spatial parameter values comprise correlation coefficients (“alpha values”) between individual discrete channels and a coupling channel.

16. The method of claim 15, wherein the prediction of an alpha value for a k^{th} stage of the method involves a reconstruction of an alpha value of a (k−1)^{th} stage of the method.

17. The method of claim 15, wherein the frequency bands include coupling channel frequency bands.

18. The method of claim 15, wherein the alpha values are shared across at least some adjacent time blocks.

19. The method of any one of claim 15, 17 or 18, further comprising performing a windowed calculation of alphas across at least one of time blocks or frequency bands.

20. The method of claim 11, wherein the dimensions include pairs of individual discrete channels.

21. The method of claim 20, wherein the parameter values comprise inter-channel correlation coefficients (“ICCs”) that indicate a correlation between the pairs of individual discrete channels.

22. The method of claim 21, wherein the first dimension comprises pairs of individual discrete channels and wherein the first vector quantization process produces first quantized ICC values.

23. The method of claim 22, wherein the first vector quantization involves:
quantizing a vector that includes ICCs of M−1 channel pairs in an Mₚ-channel-pair cycle, to produce quantized values of the M−1 ICCs;
calculating a range in which the Mₚ^{th} ICC lies based, at least in part, on the quantized values of the M−1 ICCs; and
quantizing the Mₚ^{th} ICC with a scalar quantizer, conditioned on the calculated range.

24. The method of any one of claims 1-23, wherein a distortion metric used to design the quantizers or in codebook search in the performing process is a mean squared error distortion metric.

25. A method, comprising:
receiving a signal comprising first and second vector quantization indices;
performing a first inverse vector quantization operation in response to the first vector quantization index to reconstruct two or more parameter values along a first dimension of an N-dimensional parameter set;
determining two or more parameter prediction values of a second dimension of the N-dimensional parameter set based at least in part on one or more of the two or more parameter values of the first dimension of the N-dimensional parameter set;
performing a second inverse vector quantization operation in response to the second vector quantization index to reconstruct two or more prediction residual values of the second dimension; and
combining the parameter prediction values of the second dimension with the prediction residual values of the second dimension to reconstruct two or more parameter values of the second dimension.

26. The method of claim 25, further comprising:
receiving a k^{th} vector quantization index;
determining two or more parameter prediction values along a k^{th} dimension of the N-dimensional parameter set, based at least in part on one or more previously determined parameter values of a dimension less than k of the N-dimensional parameter set;
performing a k^{th} inverse vector quantization operation in response to the k^{th} vector quantization index to reconstruct two or more prediction residual values of the k^{th} dimension; and
combining the parameter prediction values of the k^{th} dimension with the prediction residual values of the k^{th} dimension to reconstruct two or more parameter values of the k^{th} dimension.

27. The method of claim 26, further comprising:
receiving an indication of a maximum vector quantizer length Mₖ for dimension k;
determining that a remaining number of parameter values Vₖ to be reconstructed along dimension k exceeds Mₖ;
reconstructing the first Mₖ values along dimension k based, at least in part, on the k^{th} quantization index;
determining, based at least in part on the k^{th} quantization index, Vₖ−Mₖ parameter prediction values of the k^{th} dimension;
receiving an additional vector quantization index for the k^{th} dimension;
performing an inverse vector quantization operation, in response to the additional vector quantization index for the k^{th} dimension, to reconstruct Vₖ−Mₖ prediction residual values of the k^{th} dimension; and
combining the Vₖ−Mₖ prediction residual values of the k^{th} dimension with the Vₖ−Mₖ parameter prediction values of the k^{th} dimension to reconstruct the remaining Vₖ−Mₖ parameter values of the k^{th} dimension.

28. The method of any one of claims 25-27, wherein:
the first vector quantization index corresponds to a memory location of a first set of quantized values; and
the second vector quantization index corresponds to a memory location of a second set of quantized values.

29. The method of any one of claims 25-28, further comprising:
receiving parameter set partition information; and
implementing the performing and determining steps according to the parameter set partition information.

30. The method of any one of claims 25-29, wherein the signal comprises encoded audio data.

31. The method of claim 30, wherein the dimensions include channels and frequency bands.

32. The method of claim 31, wherein the dimensions include time blocks.

33. The method of claim 31 or claim 32, wherein the parameter values comprise spatial parameter values.

34. The method of claim 33, wherein the spatial parameter values comprise correlation coefficients (“alpha values”) between individual discrete channels and a coupling channel.

35. The method of claim 34, wherein the prediction of an alpha value for a k^{th} stage of the method involves a reconstruction of an alpha value of a (k−1)^{th} stage of the method.

36. The method of claim 34, wherein the frequency bands include coupling channel frequency bands.

37. The method of claim 34, wherein the alpha values are shared across at least some adjacent time blocks.

38. The method of claim 30, wherein the dimensions include pairs of individual discrete channels.

39. The method of claim 38, wherein the parameter values comprise inter-channel correlation coefficients (“ICCs”) that indicate a correlation between the pairs of individual discrete channels.

40. An apparatus, comprising:
an interface; and
a logic system capable of:
receiving, via the interface, a signal;
analyzing the signal to determine parameter values of an N-dimensional parameter set;
applying a first vector quantization process to two or more parameter values along a first dimension of the N-dimensional parameter set to produce a first set of quantized values;
calculating two or more parameter prediction values along a second dimension of the N-dimensional parameter set based, at least in part, on one or more values of the first set of quantized values;
calculating prediction residual values based, at least in part, on the parameter prediction values; and
applying a second vector quantization process to the prediction residual values to produce a second set of quantized values.

41. The apparatus of claim 40, wherein the logic system is further capable of:
determining a first vector quantization index corresponding to the first set of quantized values; and
determining a second vector quantization index corresponding to the second set of quantized values.

42. The apparatus of claim 41, wherein the first and second quantization indices comprise pointers to data structure locations at which the first and second sets of quantized values, respectively, are stored.

43. The apparatus of any one of claims 40-42, wherein the logic system is further capable of:
calculating two or more parameter prediction values along a k^{th} dimension of the N-dimensional parameter set, based at least in part on one or more values of one or more of (k−1) previously produced sets of quantized values;
calculating prediction residual values based at least in part on the parameter prediction values along the k^{th} dimension; and
applying a k^{th} vector quantization process to the prediction residual values along the k^{th} dimension to produce a k^{th} set of quantized values.

44. The apparatus of any one of claims 40-43, wherein the logic system is further capable of:
determining a maximum vector quantizer length Mₖ for dimension k;
determining that a number of values Vₖ to be vector quantized exceeds Mₖ;
determining Vₖ−Mₖ remaining values to be vector quantized;
predicting, based at least in part on at least one of the Mₖ quantized values, Vₖ−Mₖ parameter prediction values along the k^{th} dimension;
calculating (Vₖ−Mₖ) k^{th} dimension prediction residual values; and
performing a vector quantization process for the (Vₖ−Mₖ) k^{th} dimension prediction residual values to produce Vₖ−Mₖ quantized values of the k^{th} parameter set.

45. The apparatus of any of claims 40-44, wherein the logic system includes at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components.

46. The apparatus of any of claims 40-45, further comprising a memory device, wherein the interface comprises an interface between the logic system and the memory device.

47. The apparatus of any of claims 40-46, wherein the interface comprises a network interface.

48. An apparatus, comprising:
an interface; and
a logic system capable of:
receiving, via the interface, a signal comprising first and second vector quantization indices;
performing a first inverse vector quantization operation in response to the first vector quantization index to reconstruct two or more parameter values along a first dimension of an N-dimensional parameter set;
determining two or more parameter prediction values of a second dimension of the N-dimensional parameter set based at least in part on one or more of the two or more parameter values of the first dimension of the N-dimensional parameter set;
performing a second inverse vector quantization operation in response to the second vector quantization index to reconstruct two or more prediction residual values of the second dimension; and
combining the parameter prediction values of the second dimension with the prediction residual values of the second dimension to reconstruct two or more parameter values of the second dimension.

49. The apparatus of claim 48, wherein the logic system is further capable of:
receiving, via the interface, a k^{th} vector quantization index;
determining two or more parameter prediction values along a k^{th} dimension of the N-dimensional parameter set, based at least in part on one or more previously determined parameter values of a dimension less than k of the N-dimensional parameter set;
performing a k^{th} inverse vector quantization operation in response to the k^{th} vector quantization index to reconstruct two or more prediction residual values of the k^{th} dimension; and
combining the parameter prediction values of the k^{th} dimension with the prediction residual values of the k^{th} dimension to reconstruct two or more parameter values of the k^{th} dimension.

50. The apparatus of claim 49, wherein the logic system is further capable of:
receiving an indication of a maximum vector quantizer length Mₖ for dimension k;
determining that a remaining number of parameter values Vₖ to be reconstructed along dimension k exceeds Mₖ;
reconstructing the first Mₖ values along dimension k based, at least in part, on the k^{th} quantization index;
determining, based at least in part on the k^{th} quantization index, Vₖ−Mₖ parameter prediction values of the k^{th} dimension;
receiving an additional vector quantization index for the k^{th} dimension;
performing an inverse vector quantization operation, in response to the additional vector quantization index for the k^{th} dimension, to reconstruct Vₖ−Mₖ prediction residual values of the k^{th} dimension; and
combining the Vₖ−Mₖ prediction residual values of the k^{th} dimension with the Vₖ−Mₖ parameter prediction values of the k^{th} dimension to reconstruct the remaining Vₖ−Mₖ parameter values of the k^{th} dimension.

51. The apparatus of any one of claims 48-50, wherein:
the first vector quantization index corresponds to a memory location of a first set of quantized values; and
the second vector quantization index corresponds to a memory location of a second set of quantized values.

52. The apparatus of any one of claims 48-51, wherein the logic system is further capable of:
receiving parameter set partition information; and
implementing the performing and determining steps according to the parameter set partition information.

53. The apparatus of any one of claims 48-52, wherein the signal comprises encoded audio data.

54. The apparatus of any of claims 48-53, wherein the logic system includes at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components.

55. The apparatus of any of claims 48-54, further comprising a memory device, wherein the interface comprises an interface between the logic system and the memory device.

56. The apparatus of any of claims 48-55, wherein the interface comprises a network interface.

57. A non-transitory medium having software stored thereon, the software including instructions for controlling at least one apparatus to:
receive a signal;
analyze the signal to determine parameter values of an N-dimensional parameter set;
apply a first vector quantization process to two or more parameter values along a first dimension of the N-dimensional parameter set to produce a first set of quantized values;
calculate two or more parameter prediction values along a second dimension of the N-dimensional parameter set based, at least in part, on one or more values of the first set of quantized values;
calculate prediction residual values based, at least in part, on the parameter prediction values; and
apply a second vector quantization process to the prediction residual values to produce a second set of quantized values.

58. The non-transitory medium of claim 57, wherein the software includes instructions for controlling the at least one apparatus to:
determine a first vector quantization index corresponding to the first set of quantized values; and
determine a second vector quantization index corresponding to the second set of quantized values.

59. The non-transitory medium of claim 58, wherein the first and second quantization indices comprise pointers to data structure locations at which the first and second sets of quantized values, respectively, are stored.

60. The non-transitory medium of any one of claims 57-59, wherein the software includes instructions for controlling the at least one apparatus to:
calculate two or more parameter prediction values along a k^{th} dimension of the N-dimensional parameter set, based at least in part on one or more values of one or more of (k−1) previously produced sets of quantized values;
calculate prediction residual values based at least in part on the parameter prediction values along the k^{th} dimension; and
apply a k^{th} vector quantization process to the prediction residual values along the k^{th} dimension to produce a k^{th} set of quantized values.

61. The non-transitory medium of any one of claims 57-60, wherein the software includes instructions for controlling the at least one apparatus to:
determine a maximum vector quantizer length Mₖ for dimension k;
determine that a number of values Vₖ to be vector quantized exceeds Mₖ;
determine Vₖ−Mₖ remaining values to be vector quantized;
predict, based at least in part on at least one of the Mₖ quantized values, Vₖ−Mₖ parameter prediction values along the k^{th} dimension;
calculate (Vₖ−Mₖ) k^{th} dimension prediction residual values; and
perform a vector quantization process for the (Vₖ−Mₖ) k^{th} dimension prediction residual values to produce Vₖ−Mₖ quantized values of the k^{th} parameter set.

62. A non-transitory medium having software stored thereon, the software including instructions for controlling at least one apparatus to:
receive a signal comprising first and second vector quantization indices;
perform a first inverse vector quantization operation in response to the first vector quantization index to reconstruct two or more parameter values along a first dimension of an N-dimensional parameter set;
determine two or more parameter prediction values of a second dimension of the N-dimensional parameter set based at least in part on one or more of the two or more parameter values of the first dimension of the N-dimensional parameter set;
perform a second inverse vector quantization operation in response to the second vector quantization index to reconstruct two or more prediction residual values of the second dimension; and
combine the parameter prediction values of the second dimension with the prediction residual values of the second dimension to reconstruct two or more parameter values of the second dimension.

63. The non-transitory medium of claim 62, wherein the software includes instructions for controlling the at least one apparatus to:
receive a k^{th} vector quantization index;
determine two or more parameter prediction values along a k^{th} dimension of the N-dimensional parameter set, based at least in part on one or more previously determined parameter values of a dimension less than k of the N-dimensional parameter set;
perform a k^{th} inverse vector quantization operation in response to the k^{th} vector quantization index to reconstruct two or more prediction residual values of the k^{th} dimension; and
combine the parameter prediction values of the k^{th} dimension with the prediction residual values of the k^{th} dimension to reconstruct two or more parameter values of the k^{th} dimension.

64. The non-transitory medium of claim 63, wherein the software includes instructions for controlling the at least one apparatus to:
receive an indication of a maximum vector quantizer length Mₖ for dimension k;
determine that a remaining number of parameter values Vₖ to be reconstructed along dimension k exceeds Mₖ;
reconstruct the first Mₖ values along dimension k based, at least in part, on the k^{th} quantization index;
determine, based at least in part on the k^{th} quantization index, Vₖ−Mₖ parameter prediction values of the k^{th} dimension;
receive an additional vector quantization index for the k^{th} dimension;
perform an inverse vector quantization operation, in response to the additional vector quantization index for the k^{th} dimension, to reconstruct Vₖ−Mₖ prediction residual values of the k^{th} dimension; and
combine the Vₖ−Mₖ prediction residual values of the k^{th} dimension with the Vₖ−Mₖ parameter prediction values of the k^{th} dimension to reconstruct the remaining Vₖ−Mₖ parameter values of the k^{th} dimension.

65. The non-transitory medium of any one of claims 62-64, wherein:
the first vector quantization index corresponds to a memory location of a first set of quantized values; and
the second vector quantization index corresponds to a memory location of a second set of quantized values.

66. The non-transitory medium of any one of claims 62-65, wherein the software includes instructions for controlling the at least one apparatus to:
receive parameter set partition information; and
implement the performing and determining steps according to the parameter set partition information.

67. The non-transitory medium of any one of claims 62-66, wherein the signal comprises encoded audio data.
